(19) United States
(12) Patent Application Publication
(10) Pub. No.: US 2025/0233638 A1
(43) Pub. Date: Jul. 17, 2025

(54) BEAM SEARCH PROCEDURES FOR MULTIPLE SPATIAL STREAMS

(71) Applicant: QUALCOMM Incorporated, San Diego, CA (US)

(72) Inventors: Tzu-Hsuan CHOU, San Diego, CA (US); Lin YANG, San Diego, CA (US); Alecsander Petru EITAN, Haifa (IL); Bin TIAN, San Diego, CA (US)

(21) Appl. No.: 18/768,429

(22) Filed: Jul. 10, 2024

Related U.S. Application Data
(60) Provisional application No. 63/619,940, filed on Jan. 11, 2024.

(51) Int. Cl. H04B 7/06; H04B 7/10

(52) U.S. Cl. CPC H04B 7/06952; H04B 7/0617; H04B 7/10

(57) ABSTRACT

This disclosure provides methods, components, devices, and systems for beam search procedures for multiple spatial streams. Some aspects more specifically relate to beamforming training procedures for multiple spatial streams. The beamforming training procedures may provide beam separation between beams during the training procedure to prevent selecting beams which lead to inter-stream interference. In some examples, a multi-stream beamforming training procedure described herein may use antenna polarization to provide beam separation. For example, different radio frequency (RF) chains may use different antenna polarizations. Additionally, or alternatively, a multi-stream beamforming training procedure may provide beam separation through antenna orientation, where different RF chains use mutually exclusive beam search regions. Additionally, or alternatively, the responder wireless communication device may iteratively select beamforming directions for spatial streams, or one-by-one, and the initiator wireless communication device may perform additional beam searches excluding directions within beam widths of previously-selected beams.

### CROSS REFERENCE

The present application for patent claims the benefit of U.S. Provisional Patent Application No. 63/619,940 by CHOU et al., entitled “BEAM SEARCH PROCEDURES FOR MULTIPLE SPATIAL STREAMS,” filed Jan. 11, 2024, assigned to the assignee hereof, and expressly incorporated by reference herein.

### TECHNICAL FIELD

This disclosure relates generally to wireless communication and, more specifically, to beam search procedures for multiple spatial streams.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some WLANs, a STA may communicate using millimeter wave radio frequency spectrum bands to increase throughput for data signaling. The STA may communicate using a lower-frequency anchor spectrum band (compared to the millimeter wave radio frequency spectrum bands) for control and BSS signaling, and use the millimeter wave radio frequency spectrum band as a data pipeline. In some examples, the STA may communicate with an AP in a WLAN over the millimeter wave radio frequency spectrum band using multiple spatial streams. The STA may perform a multi-stream beamforming training procedure to identify a respective beamforming direction for each of the spatial streams. If the multi-stream beamforming training procedure selects similar beamforming directions for multiple of the spatial streams, however, there may cause inter-stream interference.

### SUMMARY

The systems, methods, and devices of this disclosure each have several innovative aspects, no single one of which is solely responsible for the desirable attributes disclosed herein.

One aspect of the subject matter described in this disclosure can be implemented in a method for wireless communication by a first wireless communication device. The method may include receiving, via a first link in a first radio frequency spectrum band, a beam search trigger for a second link in a second radio frequency spectrum band, receiving, over the second link via a set of multiple receive radio frequency chains of the first wireless communication device, a set of multiple training signals from a set of multiple transmit radio frequency chains of a second wireless communication device in accordance with the beam search trigger, selecting a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains, and selecting a beamforming direction for each spatial stream of the set of spatial streams in accordance with the set of multiple training signals.

Another aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to receive, via a first link in a first radio frequency spectrum band, a beam search trigger for a second link in a second radio frequency spectrum band, receive, over the second link via a set of multiple receive radio frequency chains of the first wireless communication device, a set of multiple training signals from a set of multiple transmit radio frequency chains of a second wireless communication device in accordance with the beam search trigger, select a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains, and select a beamforming direction for each spatial stream of the set of spatial streams in accordance with the set of multiple training signals.

Another aspect of the subject matter described in this disclosure can be implemented in a first wireless communication device for wireless communication. The first wireless communication device may include means for receiving, via a first link in a first radio frequency spectrum band, a beam search trigger for a second link in a second radio frequency spectrum band, means for receiving, over the second link via a set of multiple receive radio frequency chains of the first wireless communication device, a set of multiple training signals from a set of multiple transmit radio frequency chains of a second wireless communication device in accordance with the beam search trigger, means for selecting a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains, and means for selecting a beamforming direction for each spatial stream of the set of spatial streams in accordance with the set of multiple training signals.

Another aspect of the subject matter described in this disclosure can be implemented in a non-transitory computer-readable medium storing code for wireless communication. The code may include instructions executable by one or more processors to receive, via a first link in a first radio frequency spectrum band, a beam search trigger for a second link in a second radio frequency spectrum band, receive, over the second link via a set of multiple receive radio frequency chains of the first wireless communication device, a set of multiple training signals from a set of multiple transmit radio frequency chains of a second wireless communication device in accordance with the beam search trigger, select a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains, and select a beamforming direction for each spatial stream of the set of spatial streams in accordance with the set of multiple training signals.

Another aspect of the subject matter described in this disclosure can be implemented in a method for wireless communication by a first wireless communication device is described. The method may include transmitting, via a first link in a first radio frequency spectrum, a beam search trigger for a second link in a second radio frequency spectrum, transmitting, over the second link via a set of multiple transmit radio frequency chains of the first wireless communication device, a set of multiple training signals to a set of multiple receive radio frequency chains of a second wireless communication device in accordance with the beam search trigger, and receiving a feedback message indicating a radio frequency chain pair for each spatial stream of a set of spatial streams and a beamforming direction for each spatial stream of the set of spatial streams.

Another aspect of the subject matter described in this disclosure can be implemented in a first wireless communication device for wireless communication. The first wireless communication device may include a processing system that includes processor circuitry and memory circuitry that stores code. The processing system may be configured to cause the first wireless communication device to transmit, via a first link in a first radio frequency spectrum, a beam search trigger for a second link in a second radio frequency spectrum, transmit, over the second link via a set of multiple transmit radio frequency chains of the first wireless communication device, a set of multiple training signals to a set of multiple receive radio frequency chains of a second wireless communication device in accordance with the beam search trigger, and receive a feedback message indicating a radio frequency chain pair for each spatial stream of a set of spatial streams and a beamforming direction for each spatial stream of the set of spatial streams.

Another aspect of the subject matter described in this disclosure can be implemented in a first wireless communication device for wireless communication. The first wireless communication device may include means for transmitting, via a first link in a first radio frequency spectrum, a beam search trigger for a second link in a second radio frequency spectrum, means for transmitting, over the second link via a set of multiple transmit radio frequency chains of the first wireless communication device, a set of multiple training signals to a set of multiple receive radio frequency chains of a second wireless communication device in accordance with the beam search trigger, and means for receiving a feedback message indicating a radio frequency chain pair for each spatial stream of a set of spatial streams and a beamforming direction for each spatial stream of the set of spatial streams.

Another aspect of the subject matter described in this disclosure can be implemented in a non-transitory computer-readable medium storing code for wireless communication. The code may include instructions executable by one or more processors to transmit, via a first link in a first radio frequency spectrum, a beam search trigger for a second link in a second radio frequency spectrum, transmit, over the second link via a set of multiple transmit radio frequency chains of the first wireless communication device, a set of multiple training signals to a set of multiple receive radio frequency chains of a second wireless communication device in accordance with the beam search trigger, and receive a feedback message indicating a radio frequency chain pair for each spatial stream of a set of spatial streams and a beamforming direction for each spatial stream of the set of spatial streams.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows an example physical layer (PHY) protocol data unit (PPDU) usable for communications between a wireless AP and one or more wireless STAs.

FIG. 4 shows a hierarchical format of an example PPDU usable for communications between a wireless AP and one or more wireless STAs.

FIG. 5 shows an example of signaling diagram that supports beam search procedures for multiple spatial streams.

FIG. 6 shows an example of a multi-stream beamforming training that supports beam search procedures for multiple spatial streams.

FIG. 7 shows an example of a multi-stream beamforming training that supports beam search procedures for multiple spatial streams.

FIG. 8 shows an example of a process flow that supports beam search procedures for multiple spatial streams.

FIG. 9 shows a block diagram of an example wireless communication device that supports beam search procedures for multiple spatial streams.

FIG. 10 shows a block diagram of an example wireless communication device that supports beam search procedures for multiple spatial streams.

FIGS. 11 and 12 show flowcharts illustrating example processes performable by or at a first wireless communication device that supports beam search procedures for multiple spatial streams.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN) or an internet of things (IoT) network.

A wireless communication device may establish communication links in multiple RF spectrum bands. For example, a wireless station (STA) may communicate control and basic service set (BSS) information with an access point (AP) on a first communication link, such as in an anchor spectrum band, and the STA may communicate data signaling on a second communication link in a higher-frequency RF spectrum band. In some examples, the STA may use multiple spatial streams for the second communication link. The STA and the AP may perform a multi-stream beam training procedure to identify beam pairs and RF chain pairs for each spatial stream. For example, the STA may select an RF chain pair, including a transmit RF chain of the AP and a receive RF chain of the STA, for each spatial stream. The STA also may select a beamforming direction for each spatial stream. Using multiple spatial streams for the second communication link may provide higher data rates and increase throughput compared to using a single spatial stream, but using multiple spatial streams may result in inter-stream interference or cross-stream interference if the selected beamforming directions for the spatial streams are too similar or overlap.

Various aspects relate generally to multi-stream beam training on a link in a high frequency band. Some aspects more specifically relate to multi-stream beamforming training procedures that provide sufficient beam separation for communication of multiple spatial streams using multiple respective beams. In some examples, the multi-stream beamforming training procedure may take advantage of different antenna polarizations and/or different antenna orientations. For example, different RF chains may use different antenna polarizations. A first RF transmit chain at an initiator wireless communication device, such as an AP, may transmit with a first polarization (such as a horizontal polarization), and a second RF transmit chain at the initiator wireless communication device may transmit with a second polarization (such as a vertical polarization). Alternatively, different RF chains may be connected with antennas having different orientations, and as such, mutually exclusive respective beam search regions. For example, a first transmit RF chain of the AP may be oriented to transmit training signals in a first set of directions, and a second transmit RF chain of the AP may be oriented to transmit training signals in a second set of directions that is non-overlapping with the first set of directions. Because of the use of opposite polarizations or mutually exclusive beam search regions, the first transmit RF chain and the second transmit RF chain may scan concurrently (such as at least partially overlapping or simultaneously) over all possible transmit beam directions. A responder wireless communication device, such as an STA, may record measurements for multiple combinations of RF chain pairs. The responder wireless communication device may then select a first RF chain pair for a first spatial stream and a second RF chain pair for a second spatial stream and may further select a respective beam direction for beamforming each of the first and second spatial streams. Additionally, or alternatively, the responder wireless communication device may iteratively select beamforming directions for spatial streams, and the initiator wireless communication device may perform additional beam searches excluding directions within some amount, such as beam widths, of previously-selected beams. For example, the initiator wireless communication device may transmit a first set of training signals using a first transmit RF chain over all beamforming directions. The responder wireless communication device may receive the first set of training signals using a first receive RF chain and select a first beamforming direction for a first spatial stream between the first transmit RF chain and the first receive RF chain based on measurements of the first set of training signals. The responder wireless communication device may indicate the first beamforming direction for the first spatial stream to the initiator wireless communication device. The initiator wireless communication device may then transmit a second set of training signals using a second transmit RF chain over a subset of all of the beamforming directions that excludes beamforming directions within a beam width of the first beamforming direction. The responder wireless communication device may receive the second set of training signals using a second receive RF chain and select a second beamforming direction for a second spatial stream between the second transmit RF chain and the second receive RF chain. Because the second set of training signals are transmitted over beamforming directions that are non-overlapping with the first beamforming direction for the first spatial stream, the first beamforming direction and the second beamforming direction may not overlap or cause inter-stream interference between the first spatial stream and the second spatial stream.

Particular aspects of the subject matter described in this disclosure can be implemented to realize one or more of the following potential advantages. In some examples, by using orthogonal or separated beams in a multi-stream beam search procedure, the described techniques reduce inter-stream interference when using multiple spatial streams for a communication link. Reducing inter-stream interference as described herein may increase a signal-to-interference plus noise ratio (SINR) and increase a quantity of effective channel paths, which may improve channel capacity, due to improved beam selection and resulting separation between beams in a multi-stream beam search procedure. In some examples, performing a beam training procedure with separation between beams may improve a rate of beam training by enabling the initiator wireless communication device and the responder wireless communication device to perform beam training for multiple spatial streams simultaneously and without inter-stream interference, as the initiator wireless communication device may simultaneously transmit training signals using orthogonal spatial beams from multiple transmit RF chains. In some examples, the separation between beams during the beam training procedure may prevent the STA from selecting overlapping beamforming directions for the beams, reducing interference between the spatial streams and improving signal quality. For example, by using different polarizations for different spatial streams, signaling from a first spatial stream may be orthogonal to signaling from a second spatial stream, which may reduce interference from the signaling of the first spatial stream to the signaling of the second spatial stream.

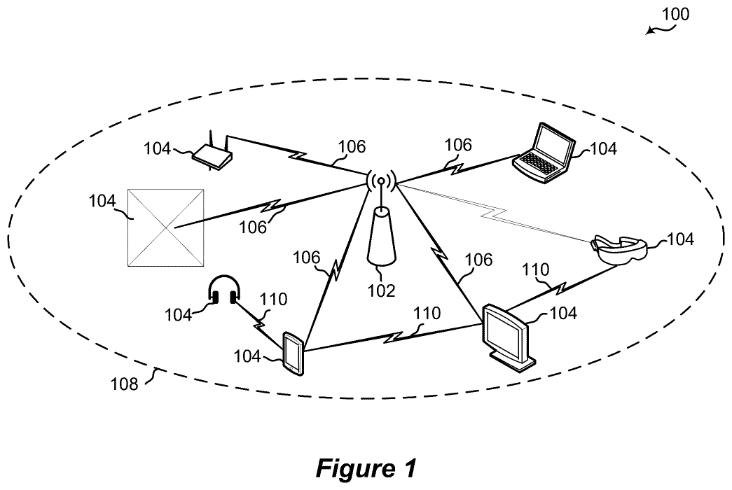

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a BSS, which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Further, as described herein, the terms “channel” and “subchannel” may be used interchangeably, and each may refer to a portion of a frequency spectrum via which communication between two or more wireless communication devices can occur. For example, a channel or subchannel may refer to a discrete portion (such as a discrete amount, span, range, or subset) of frequency of an operating bandwidth. A channel or subchannel may refer to a 20 MHz portion, a 40 MHz portion, an 80 MHz portion, or a 160 MHz portion, among other examples. In other words, a channel or subchannel may include one or more 20 MHz channels. A primary channel or subchannel may be understood as a portion of a frequency spectrum that includes a primary 20 MHz used for beaconing, among other (management) frame transmissions. A secondary channel or subchannel may be understood as a portion of a frequency spectrum that excludes the primary 20 MHz (or that at least excludes a main primary (M-Primary) channel). In some systems, a secondary channel or subchannel may include an opportunistic primary (O-Primary) channel. A wireless communication device may use an M-Primary channel (such as an M-Primary 20 MHz) for beaconing and/or serving legacy clients and may use an O-Primary channel (such as an O-Primary 20 MHz) for opportunistic access on one or more other channels (such as if the M-Primary channel is busy or occupied).

In some aspects, different portions of a frequency spectrum (such as a 40 MHz portion, an 80 MHz portion, or a 160 MHz portion) may be associated with multiple (20 MHz) subchannels and at least one anchor subchannel. In such aspects, an anchor subchannel may define, indicate, or identify a lowest (20 MHz) subchannel within a given portion of a frequency spectrum. For example, a first anchor subchannel may define, indicate, or identify a lowest 20 MHz subchannel within a secondary 40 MHz bandwidth, a second anchor subchannel may define, indicate, or identify a lowest 20 MHz subchannel within a secondary 80 MHz bandwidth, and a third anchor subchannel may define, indicate, or identify a lowest 20 MHz subchannel within a secondary 160 MHz bandwidth. In some aspects, a wireless communication device may use an anchor subchannel as an O-Primary channel.

In some examples, the AP 102 or the STAs 104 of the wireless communication network 100 may implement Extremely High Throughput (EHT) or other features compliant with current and future generations of the IEEE 802.11 family of wireless communication protocol standards (such as the IEEE 802.11be and 802.11bn standard amendments) to provide additional capabilities over other previous systems (such as High Efficiency (HE) systems or other legacy systems). For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT and newer wireless communication protocols (such as the protocols referred to as or associated with the IEEE 802.11bn standard amendment) may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz. EHT systems may support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In non-contiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT enhancements such as increased bandwidth, puncturing, or refinements to carrier sensing and signal reporting mechanisms.

A multi-stream beamforming training procedure described herein may provide some separation between beams to avoid inter-stream interference. For example, a multi-stream beamforming training procedure may use antenna polarization at different RF chains. A first RF transmit chain at an initiator wireless communication device, such as an AP, may transmit with horizontal polarization, and a second RF transmit chain at the initiator wireless communication device may transmit with vertical polarization. Similarly a first RF receive chain at a responder wireless communication device, such as a STA, may receive with horizontal polarization, and a second RF receive chain at the responder wireless communication device may receive with vertical polarization. Additionally, or alternatively, a multi-stream beamforming training procedure may provide beam separation through antenna orientation. For example, different Tx or Rx RF chains may use or be assigned mutually exclusive beam search regions. Additionally, or alternatively, the responder wireless communication device may iteratively select beamforming directions for spatial streams, or one-by-one, and the initiator wireless communication device may perform additional beam searches excluding directions within beam widths of previously-selected beams.

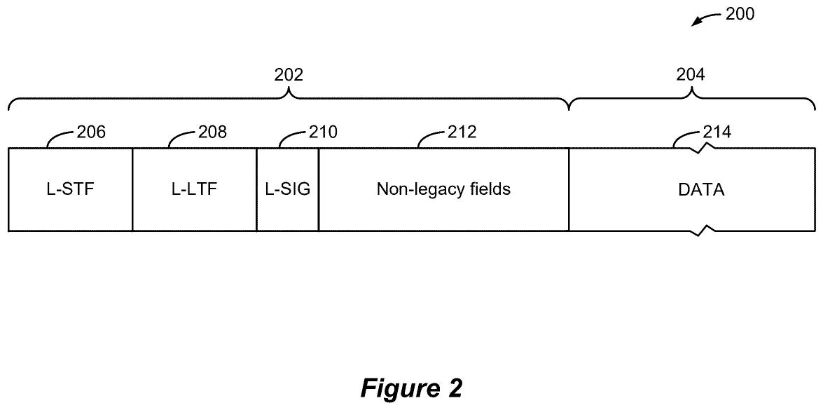

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (such as obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

A multi-stream beamforming training procedure may implement aspects of the example PDU 200 usable for communications between a wireless AP and one or more wireless STAs. The multi-stream beamforming training procedure described herein may provide some separation between beams to avoid inter-stream interference. For example, a multi-stream beamforming training procedure may use antenna polarization at different RF chains. A first RF transmit chain at an initiator wireless communication device, such as an AP, may transmit with horizontal polarization, and a second RF transmit chain at the initiator wireless communication device may transmit with vertical polarization. Similarly, a first RF receive chain at a responder wireless communication device, such as a STA, may receive with horizontal polarization, and a second RF receive chain at the responder wireless communication device may receive with vertical polarization. Additionally, or alternatively, a multi-stream beamforming training procedure may provide beam separation through antenna orientation. For example, different Tx or Rx RF chains may use or be assigned mutually exclusive beam search regions. Additionally, or alternatively, the responder wireless communication device may iteratively select beamforming directions for spatial streams, or one-by-one, and the initiator wireless communication device may perform additional beam searches excluding directions within beam widths of previously-selected beams.

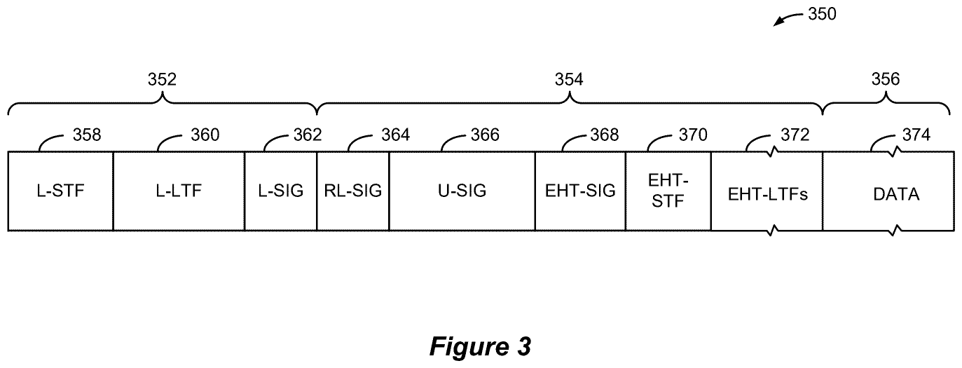

FIG. 3 shows an example physical layer (PHY) protocol data unit (PPDU) 350 usable for communications between a wireless AP and one or more wireless STAs. For example, the AP and STAs may be examples of the AP 102 and the STAs 104 described with reference to FIG. 1. As shown, the PPDU 350 includes a PHY preamble, that includes a legacy portion 352 and a non-legacy portion 354, and a payload 356 that includes a data field 374. The legacy portion 352 of the preamble includes an L-STF 358, an L-LTF 360, and an L-SIG 362. The non-legacy portion 354 of the preamble includes a repetition of L-SIG (RL-SIG) 364 and multiple wireless communication protocol version-dependent signal fields after RL-SIG 364. For example, the non-legacy portion 354 may include a universal signal field 366 (referred to herein as “U-SIG 366”) and an EHT signal field 368 (referred to herein as “EHT-SIG 368”). The presence of RL-SIG 364 and U-SIG 366 may indicate to EHT- or later version-compliant STAs 104 that the PPDU 350 is an EHT PPDU or a PPDU conforming to any later (post-EHT) version of a new wireless communication protocol conforming to a future IEEE 802.11 wireless communication protocol standard. One or both of U-SIG 366 and EHT-SIG 368 may be structured as, and carry version-dependent information for, other wireless communication protocol versions associated with amendments to the IEEE family of standards beyond EHT. For example, U-SIG 366 may be used by a receiving device (such as an AP 102 or a STA 104) to interpret bits in one or more of EHT-SIG 368 or the data field 374. Like L-STF 358, L-LTF 360, and L-SIG 362, the information in U-SIG 366 and EHT-SIG 368 may be duplicated and transmitted in each of the component 20 MHz channels in instances involving the use of a bonded channel.

The non-legacy portion 354 further includes an additional short training field 370 (referred to herein as “EHT-STF 370,” although it may be structured as, and carry version-dependent information for, other wireless communication protocol versions beyond EHT) and one or more additional long training fields 372 (referred to herein as “EHT-LTFs 372,” although they may be structured as, and carry version-dependent information for, other wireless communication protocol versions beyond EHT). EHT-STF 370 may be used for timing and frequency tracking and AGC, and EHT-LTF 372 may be used for more refined channel estimation.

EHT-SIG 368 may be used by an AP 102 to identify and inform one or multiple STAs 104 that the AP 102 has scheduled uplink (UL) or downlink (DL) resources for them. EHT-SIG 368 may be decoded by each compatible STA 104 served by the AP 102. EHT-SIG 368 may generally be used by the receiving device to interpret bits in the data field 374. For example, EHT-SIG 368 may include resource unit (RU) allocation information, spatial stream configuration information, and per-user (such as STA-specific) signaling information. Each EHT-SIG 368 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific MCS values and user-specific RU allocation information. Such information enables the respective STAs 104 to identify and decode corresponding RUs in the associated data field 374.

A multi-stream beamforming training procedure may implement aspects of the PPDU 350 usable for communications between a wireless AP and one or more wireless STAs. The multi-stream beamforming training procedure described herein may provide some separation between beams to avoid inter-stream interference. For example, a multi-stream beamforming training procedure may use antenna polarization at different RF chains. A first RF transmit chain at an initiator wireless communication device, such as an AP, may transmit with horizontal polarization, and a second RF transmit chain at the initiator wireless communication device may transmit with vertical polarization. Similarly a first RF receive chain at a responder wireless communication device, such as a STA, may receive with horizontal polarization, and a second RF receive chain at the responder wireless communication device may receive with vertical polarization. Additionally, or alternatively, a multi-stream beamforming training procedure may provide beam separation through antenna orientation. For example, different Tx and Rx RF chains may use or be assigned mutually exclusive beam search regions. Additionally, or alternatively, the responder wireless communication device may iteratively select beamforming directions for spatial streams, or one-by-one, and the initiator wireless communication device may perform additional beam searches excluding directions within beam widths of previously-selected beams.

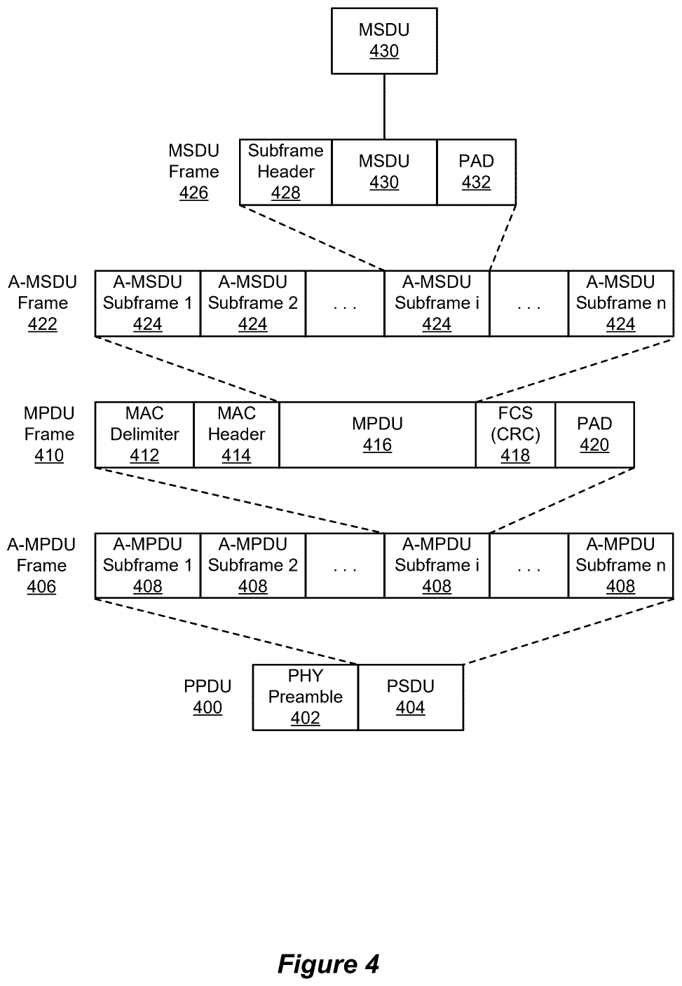

FIG. 4 shows a hierarchical format of an example PPDU usable for communications between a wireless AP and one or more wireless STAs. For example, the AP and STAs may be examples of the AP 102 and the STAs 104 described with reference to FIG. 1. As described, each PPDU 400 includes a PHY preamble 402 and a PSDU 404. Each PSDU 404 may represent (or “carry”) one or more MAC protocol data units (MPDUs) 416. For example, each PSDU 404 may carry an aggregated MPDU (A-MPDU) 406 that includes an aggregation of multiple A-MPDU subframes 408. Each A-MPDU subframe 408 may include an MPDU frame 410 that includes a MAC delimiter 412 and a MAC header 414 prior to the accompanying MPDU 416, which includes the data portion (“payload” or “frame body”) of the MPDU frame 410. Each MPDU frame 410 also may include a frame check sequence (FCS) field 418 for error detection (such as the FCS field 418 may include a cyclic redundancy check (CRC)) and padding bits 420. The MPDU 416 may carry one or more MAC service data units (MSDUs) 430. For example, the MPDU 416 may carry an aggregated MSDU (A-MSDU) 422 including multiple A-MSDU subframes 424. Each A-MSDU subframe 424 may be associated with (such as an example of or otherwise referred to as) an MSDU frame 426 and may contain a corresponding MSDU 430 preceded by a subframe header 428 and, in some examples, followed by padding bits 432.

Referring back to the MPDU frame 410, the MAC delimiter 412 may serve as a marker of the start of the associated MPDU 416 and indicate the length of the associated MPDU 416. The MAC header 414 may include multiple fields containing information that defines or indicates characteristics or attributes of data encapsulated within the frame body. The MAC header 414 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration and enables the receiving device to establish its network allocation vector (NAV). The MAC header 414 also includes one or more fields indicating addresses for the data encapsulated within the frame body. For example, the MAC header 414 may include a combination of a source address, a transmitter address, a receiver address, or a destination address. The MAC header 414 may further include a frame control field containing control information. The frame control field may specify a frame type, for example, a data frame, a control frame, or a management frame.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Access to the shared wireless medium is generally governed by a distributed coordination function (DCF). With a DCF, there is generally no centralized master device allocating time and frequency resources of the shared wireless medium. On the contrary, before a wireless communication device, such as an AP 102 or a STA 104, is permitted to transmit data, it may wait for a particular time and then contend for access to the wireless medium. The DCF is implemented through the use of time intervals (including the slot time (or “slot interval”) and the inter-frame space (IFS). IFS provides priority access for control frames used for proper network operation. Transmissions may begin at slot boundaries. Different varieties of IFS exist including the short IFS (SIFS), the distributed IFS (DIFS), the extended IFS (EIFS), and the arbitration IFS (AIFS). The values for the slot time and IFS may be provided by a suitable standard specification, such as one or more of the IEEE 802.11 family of wireless communication protocol standards.

In some examples, the wireless communication device (such as the AP 102 or the STA 104) may implement the DCF through the use of carrier sense multiple access (CSMA) with collision avoidance (CA) (CSMA/CA) techniques. According to such techniques, before transmitting data, the wireless communication device may perform a clear channel assessment (CCA) and may determine (such as identify, detect, ascertain, calculate, or compute) that the relevant wireless channel is idle. The CCA includes both physical (PHY-level) carrier sensing and virtual (MAC-level) carrier sensing. Physical carrier sensing is accomplished via a measurement of the received signal strength of a valid frame, which is compared to a threshold to determine (such as identify, detect, ascertain, calculate, or compute) whether the channel is busy. For example, if the received signal strength of a detected preamble is above a threshold, the medium is considered busy. Physical carrier sensing also includes energy detection. Energy detection involves measuring the total energy the wireless communication device receives regardless of whether the received signal represents a valid frame. If the total energy detected is above a threshold, the medium is considered busy.

Virtual carrier sensing is accomplished via the use of a network allocation vector (NAV), which effectively serves as a time duration that elapses before the wireless communication device may contend for access even in the absence of a detected symbol or even if the detected energy is below the relevant threshold. The NAV is reset each time a valid frame is received that is not addressed to the wireless communication device. When the NAV reaches 0, the wireless communication device performs the physical carrier sensing. If the channel remains idle for the appropriate IFS, the wireless communication device initiates a backoff timer, which represents a duration of time that the device senses the medium to be idle before it is permitted to transmit. If the channel remains idle until the backoff timer expires, the wireless communication device becomes the holder (or “owner”) of a transmit opportunity (TXOP) and may begin transmitting. The TXOP is the duration of time the wireless communication device can transmit frames over the channel after it has “won” contention for the wireless medium. The TXOP duration may be indicated in the U-SIG field of a PPDU. If, on the other hand, one or more of the carrier sense mechanisms indicate that the channel is busy, a MAC controller within the wireless communication device will not permit transmission.

Each time the wireless communication device generates a new PPDU for transmission in a new TXOP, it randomly selects a new backoff timer duration. The available distribution of the numbers that may be randomly selected for the backoff timer is referred to as the contention window (CW). There are different CW and TXOP durations for each of the four access categories (ACs): voice (AC_VO), video (AC_VI), background (AC_BK), and best effort (AC_BE). This enables particular types of traffic to be prioritized in the network.

In some other examples, the wireless communication device (such as the AP 102 or the STA 104) may contend for access to the wireless medium of a WLAN in accordance with an enhanced distributed channel access (EDCA) procedure. A random channel access mechanism such as EDCA may afford high-priority traffic a greater likelihood of gaining medium access than low-priority traffic. The wireless communication device using EDCA may classify data into different access categories. Each AC may be associated with a different priority level and may be assigned a different range of random backoffs (RBOs) so that higher priority data is more likely to win a TXOP than lower priority data (such as by assigning lower RBOs to higher priority data and assigning higher RBOs to lower priority data). Although EDCA increases the likelihood that low-latency data traffic will gain access to a shared wireless medium during a given contention period, unpredictable outcomes of medium access contention operations may prevent low-latency applications from achieving certain levels of throughput or satisfying certain latency requirements.

Some APs and STAs (such as the AP 102 and the STAs 104 described with reference to FIG. 1) may implement spatial reuse techniques. For example, APs 102 and STAs 104 configured for communications using the protocols defined in the IEEE 802.11ax or 802.11be standard amendments may be configured with a BSS color. APs 102 associated with different BSSs may be associated with different BSS colors. A BSS color is a numerical identifier of an AP 102's respective BSS (such as a 6 bit field carried by the SIG field). Each STA 104 may learn its own BSS color upon association with the respective AP 102. BSS color information is communicated at both the PHY and MAC sublayers. If an AP 102 or a STA 104 detects, obtains, selects, or identifies, a wireless packet from another wireless communication device while contending for access, the AP 102 or STA 104 may apply different contention parameters in accordance with whether the wireless packet is transmitted by, or transmitted to, another wireless communication device (such another AP 102 or STA 104) within its BSS or from a wireless communication device from an overlapping BSS (OBSS), as determined, identified, ascertained, or calculated by a BSS color indication in a preamble of the wireless packet. For example, if the BSS color associated with the wireless packet is the same as the BSS color of the AP 102 or STA 104, the AP 102 or STA 104 may use a first RSSI detection threshold when performing a CCA on the wireless channel. However, if the BSS color associated with the wireless packet is different than the BSS color of the AP 102 or STA 104, the AP 102 or STA 104 may use a second RSSI detection threshold in lieu of using the first RSSI detection threshold when performing the CCA on the wireless channel, the second RSSI detection threshold being greater than the first RSSI detection threshold. In this way, the criteria for winning contention are relaxed when interfering transmissions are associated with an OBSS.

Some APs and STAs (such as the AP 102 and the STAs 104 described with reference to FIG. 1) may implement techniques for spatial reuse that involve participation in a coordinated communication scheme. According to such techniques, an AP 102 may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP. The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions of the TXOP. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some examples of OFDMA techniques, each portion of the plurality of portions of the TXOP includes a set of frequency resources that do not overlap with any frequency resources of any other portion of the plurality of portions. In such examples, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or enhanced distributed channel access (EDCA) techniques. Additionally, by enabling a group of APs 102 associated with different BSSs to participate in a coordinated AP transmission session, during which the group of APs may share at least a portion of a single TXOP obtained by any one of the participating APs, such techniques may increase throughput across the BSSs associated with the participating APs and also may achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs 104 associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, a receive (RX) power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may be allocated resources during the TXOP as described above.

Retransmission protocols, such as hybrid automatic repeat request (HARQ), also may offer performance gains. A HARQ protocol may support various HARQ signaling between transmitting and receiving wireless communication devices (such as the AP 102 and the STAs 104 described with reference to FIG. 1) as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, if a receiving device cannot properly decode (and cannot correct the errors) a first HARQ transmission received from the transmitting device, the receiving device may transmit a HARQ feedback message to the transmitting device (such as a negative acknowledgment (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an automatic repeat request (ARQ) protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

APs and STAs (such as the AP 102 and the STAs 104 described with reference to FIG. 1) that include multiple antennas may support various diversity schemes. For example, spatial diversity may be used by one or both of a transmitting device (such as either an AP 102 or a STA 104) or a receiving device (such as either an AP 102 or a STA 104) to increase the robustness of a transmission. For example, to implement a transmit diversity scheme, a transmitting device may transmit the same data redundantly over two or more antennas.

APs 102 and STAs 104 that include multiple antennas also may support space-time block coding (STBC). With STBC, a transmitting device also transmits multiple copies of a data stream across multiple antennas to exploit the various received versions of the data to increase the likelihood of decoding the correct data. More specifically, the data stream to be transmitted is encoded in blocks, which are distributed among the spaced antennas and across time. Generally, STBC can be used when the number N_{Tx} of transmit antennas exceeds the number N_{SS} of spatial streams. The N_{SS} spatial streams may be mapped to a number N_{STS} of space-time streams, which are mapped to N_{Tx} transmit chains.

APs 102 and STAs 104 that include multiple antennas also may support spatial multiplexing, which may be used to increase the spectral efficiency and the resultant throughput of a transmission. To implement spatial multiplexing, the transmitting device divides the data stream into a number N_{SS} of separate, independent spatial streams. The spatial streams are separately encoded and transmitted in parallel via the multiple N_{Tx} transmit antennas.

APs 102 and STAs 104 that include multiple antennas also may support beamforming. Beamforming generally refers to the steering of the energy of a transmission in the direction of a target receiver. Beamforming may be used both in a single-user (SU) context, for example, to improve a signal-to-noise ratio (SNR), as well as in a multi-user (MU) context, for example, to enable MU-MIMO transmissions (also referred to as spatial division multiple access (SDMA)). In the MU-MIMO context, beamforming may additionally, or alternatively, involve the nulling out of energy in the directions of other receiving devices. To perform SU beamforming or MU-MIMO, a transmitting device, referred to as the beamformer, transmits a signal from each of multiple antennas. The beamformer configures the amplitudes and phase shifts between the signals transmitted from the different antennas such that the signals add constructively along particular directions towards the intended receiver (referred to as the beamformee) or add destructively in other directions towards other devices to mitigate interference in a MU-MIMO context. The manner in which the beamformer configures the amplitudes and phase shifts depends on channel state information (CSI) associated with the wireless channels over which the beamformer intends to communicate with the beamformee.

To obtain the CSI necessary for beamforming, the beamformer may perform a channel sounding procedure with the beamformee. For example, the beamformer may transmit one or more sounding signals (such as in the form of a null data packet (NDP)) to the beamformee. An NDP is a PPDU without any data field. The beamformee may perform measurements for each of the N_{Tx}×N_{Rx} sub-channels corresponding to all of the transmit antenna and receive antenna pairs associated with the sounding signal. The beamformee generates a feedback matrix associated with the channel measurements and, typically, compresses the feedback matrix before transmitting the feedback to the beamformer. The beamformer may generate a precoding (or “steering”) matrix for the beamformee associated with the feedback and use the steering matrix to precode the data streams to configure the amplitudes and phase shifts for subsequent transmissions to the beamformee. The beamformer may use the steering matrix to determine (such as identify, detect, ascertain, calculate, or compute) how to transmit a signal on each of its antennas to perform beamforming. For example, the steering matrix may be indicative of a phase shift or a power level. to use to transmit a respective signal on each of the beamformer's antennas.

When performing beamforming, the transmitting beamforming array gain is logarithmically proportional to the ratio of N_{Tx} to N_{SS}. As such, it is generally desirable, within other constraints, to increase the number N_{Tx} of transmit antennas when performing beamforming to increase the gain. It is also possible to more accurately direct transmissions or nulls by increasing the number of transmit antennas. This is especially advantageous in MU transmission contexts in which it is particularly important to reduce inter-user interference.

To increase an AP 102's spatial multiplexing capability, an AP 102 may need to support an increased number of spatial streams (such as up to 16 spatial streams). However, supporting additional spatial streams may result in increased CSI feedback overhead. Implicit CSI acquisition techniques may avoid CSI feedback overhead by taking advantage of the assumption that the UL and DL channels have reciprocal impulse responses (that is, that there is channel reciprocity). For example, the CSI feedback overhead may be reduced using an implicit channel sounding procedure such as an implicit beamforming report (BFR) technique (such as where STAs 104 transmit NDP sounding packets in the UL while the AP 102 measures the channel) because no BFRs are sent. Once the AP 102 receives the NDPs, it may implicitly assess the channels for each of the STAs 104 and use the channel assessments to configure steering matrices. In order to mitigate hardware mismatches that could break the channel reciprocity on the UL and DL (such as the baseband-to-RF and RF-to-baseband chains not being reciprocal), the AP 102 may implement a calibration method to compensate for the mismatch between the UL and the DL channels. For example, the AP 102 may select a reference antenna, transmit a pilot signal from each of its antennas, and estimate baseband-to-RF gain for each of the non-reference antennas relative to the reference antenna.

In some examples, multiple APs 102 may simultaneously transmit signaling or communications to a single STA 104 utilizing a distributed MU-MIMO scheme. Examples of such a distributed MU-MIMO transmission include coordinated beamforming (CBF) and joint transmission (JT). With CBF, signals (such as data streams) for a given STA 104 may be transmitted by only a single AP 102. However, the coverage areas of neighboring APs may overlap, and signals transmitted by a given AP 102 may reach the STAs in OBSSs associated with neighboring APs as OBSS signals. CBF allows multiple neighboring APs to transmit simultaneously while minimizing or avoiding interference, which may result in more opportunities for spatial reuse. More specifically, using CBF techniques, an AP 102 may beamform signals to in-BSS STAs 104 while forming nulls in the directions of STAs in OBSSs such that any signals received at an OBSS STA are of sufficiently low power to limit the interference at the STA. To accomplish this, an inter-BSS coordination set may be defined between the neighboring APs, which contains identifiers of all APs and STAs participating in CBF transmissions.

With JT, signals for a given STA 104 may be transmitted by multiple coordinated APs 102. For the multiple APs 102 to concurrently transmit data to a STA 104, the multiple APs 102 may all need a copy of the data to be transmitted to the STA 104. Accordingly, the APs 102 may need to exchange the data among each other for transmission to a STA 104. With JT, the combination of antennas of the multiple APs 102 transmitting to one or more STAs 104 may be considered as one large antenna array (which may be represented as a virtual antenna array) used for beamforming and transmitting signals. In combination with MU-MIMO techniques, the multiple antennas of the multiple APs 102 may be able to transmit data via multiple spatial streams. Accordingly, each STA 104 may receive data via one or more of the multiple spatial streams.

In some implementations, the AP 102 and STAs 104 can support various multi-user communications; that is, concurrent transmissions from one device to each of multiple devices (such as multiple simultaneous downlink communications from an AP 102 to corresponding STAs 104), or concurrent transmissions from multiple devices to a single device (such as multiple simultaneous uplink transmissions from corresponding STAs 104 to an AP 102). As an example, in addition to MU-MIMO, the AP 102 and STAs 104 may support OFDMA. OFDMA is in some aspects a multi-user version of OFDM.

In OFDMA schemes, the available frequency spectrum of the wireless channel may be divided into multiple resource units (RUs) each including multiple frequency subcarriers (also referred to as “tones”). Different RUs may be allocated or assigned by an AP 102 to different STAs 104 at particular times. The sizes and distributions of the RUs may be referred to as an RU allocation. In some examples, RUs may be allocated in 2 MHz intervals, and as such, the smallest RU may include 26 tones consisting of 24 data tones and 2 pilot tones. Consequently, in a 20 MHz channel, up to 9 RUs (such as 2 MHz, 26-tone RUs) may be allocated (because some tones are reserved for other purposes). Similarly, in a 160 MHz channel, up to 74 RUs may be allocated. Other tone RUs also may be allocated, such as 52 tone, 106 tone, 242 tone, 484 tone and 996 tone RUs. Adjacent RUs may be separated by a null subcarrier (such as a DC subcarrier), for example, to reduce interference between adjacent RUs, to reduce receiver DC offset, and to avoid transmit center frequency leakage.

For UL MU transmissions, an AP 102 can transmit a trigger frame to initiate and synchronize an UL OFDMA or UL MU-MIMO transmission from multiple STAs 104 to the AP 102. Such trigger frames may thus enable multiple STAs 104 to send UL traffic to the AP 102 concurrently in time. A trigger frame may address one or more STAs 104 through respective association identifiers (AIDs), and may assign each AID (and thus each STA 104) one or more RUs that can be used to send UL traffic to the AP 102. The AP also may designate one or more random access (RA) RUs that unscheduled STAs 104 may contend for.

Some APs and STAs, such as, for example, the AP 102 and STAs 104 described with reference to FIG. 1, are capable of multi-link operation (MLO). For example, the AP 102 and STAs 104 may support MLO as defined in one or both of the IEEE 802.11be and 802.11bn standard amendments. An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the DL direction or the UL direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a TDM manner. In contrast, some MLSR MLDs may further be capable of an enhanced MLSR (eMLSR) mode of operation, in which the MLD can concurrently listen on multiple links for specific types of packets, such as buffer status report poll (BSRP) frames or multi-user (MU) request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, a single mobility domain (SMD) entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block ACK) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD

A multi-stream beamforming training procedure may implement aspects of the hierarchical format of the example PPDU usable for communications between a wireless AP and one or more wireless STAs. The multi-stream beamforming training procedure described herein may provide some separation between beams to avoid inter-stream interference. For example, a multi-stream beamforming training procedure may use antenna polarization at different RF chains. A first RF transmit chain at an initiator wireless communication device, such as an AP, may transmit with horizontal polarization, and a second RF transmit chain at the initiator wireless communication device may transmit with vertical polarization. Additionally, or alternatively, a multi-stream beamforming training procedure may provide beam separation through antenna orientation. For example, different RF chains may use or be assigned mutually exclusive beam search regions. Additionally, or alternatively, the responder wireless communication device may iteratively select beamforming directions for spatial streams, or one-by-one, and the initiator wireless communication device may perform additional beam searches excluding directions within beam widths of previously-selected beams.

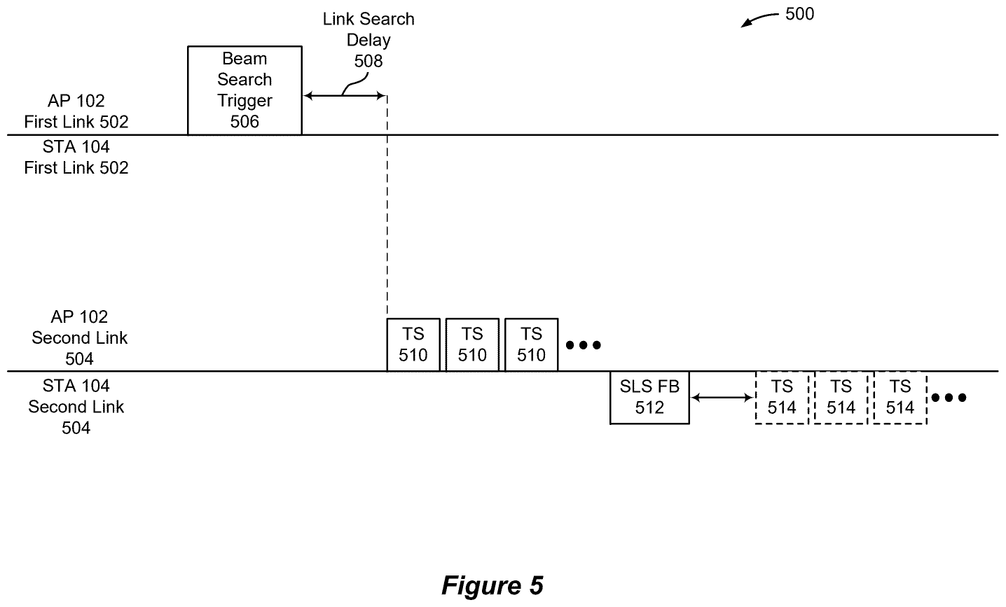

FIG. 5 shows an example of a signaling diagram 500 that supports beam search procedures for multiple spatial streams.

A STA 104 may communicate using multiple communication links. For example, the STA 104 may communicate with an AP 102 using a first link 502 and a second link 504. The first link 502 may be an example of an anchor link. In some examples, the first link 502 may be in a sub-7 GHz radio frequency spectrum band. The STA 104 and the AP 102 may communicate control information and BSS management information via the first link 502. In some examples, the first link 502 may support a 320 MHz channel.

The second link 504 may be in a higher-frequency radio frequency spectrum band. For example, the second link 504 may be in a millimeter wave band, such as a 45 GHz or 60 GHz radio frequency spectrum band. The second link 504 may be integrated with the first link 502, or used together with the first link 502 to provide control information over the first link and data signaling over the second link 504. For example, the second link 504 may have greater data throughput but reduced range and lower reliability than the first link 502 due to the higher-frequency of the second link. In some examples, the second link 504 may serve as a data pipeline for the STA 104, while the first link 502 may be used for control signaling.

In some examples, separate APs 102 may provide the first link 502 and the second link 504. For example, a first AP 102 may provide the first link 502, and a second AP 102 may provide the second link 504. The first AP 102 and the second AP 102 may be in communication, connected, or in sync, or any combination thereof, such as through multi-AP coordination. For example, the first AP 102 and the second AP 102 may communicate via a wired or wireless backhaul.

In some examples, the STA 104 may receive a beam search trigger 506 for the second link 504 via the first link 502. For example, the AP 102 may transmit the beam search trigger 506 to the STA 104 via the first link 502. The beam search trigger 506 may trigger the STA 104 to perform a beam search or beam training procedure on the second link 504. In examples where separate APs 102 provide the first link and the second link, the first AP 102 may send an indication of the beam search trigger 506 to the second AP 102 and the STA 104. In some examples, the trigger frame (the beam search trigger 506) may sync the AP 102 and the STA 104 for the beam training procedure. In some examples, the terms “beam search procedure,” “beam training procedure,” “beamforming training procedure,” and “beam search,” and “beamforming training” may be used interchangeably.

The STA 104 may receive the beam search trigger 506 from the first link 502 for control information and switch to the second link 504. The STA 104 may pre-correct timing and frequency offset for the beam search procedure. In some examples, switching to the second link 504 or correcting timing and frequency information for the beam search procedure, or both, may correspond to a link search delay 508 between receiving the beam search trigger 506 and monitoring for or receiving training signals 510 for the beam search procedure. The STA 104 may wait for training signals, or beam training sequences, from the AP 102-a over the second link 504.

For a one-stream data transmission, the AP 102 may transmit a set of training sequences to the STA 104. In some examples, the AP 102 and the STA 104 may perform a beam search scan to select a best beam-pair from the combination of transmitter codebook F and receiver codebook W. For example, the AP 102 may transmit a training signal across all beams of the transmitter codebook F, and the STA 104 may receive and measure the training signals using one configuration of the receiver codebook W. The STA 104 may use the next receiver codebook configuration, and the AP 102 may transmit a training signal across all beams of the transmitter codebook F again. For example, the total quantity of candidate beams may be |W×F|, or all combinations of the transmitter codebook and the receiver codebook. This type of beam search procedure may be referred to as a 2D scan.

In some examples, the AP 102 and the STA 104 may perform a first stage of a beam search procedure to select a best transmit beam from the transmitter codebook. For example, the AP 102 may transmit training signals to the STA 104 using all transmit beams of the transmitter codebook, and the STA 104 may use an omni or a quasi-omnidirectional receive beam to receive and measure the training signals. The first stage of the beam search procedure may be referred to as a transmitter sector-level sweep (SLS).

Using the best transmit beam, the AP 102 and the STA 104 may perform a second stage of the beam search procedure to select a best receive beam from the receiver codebook. For example, the AP 102 may transmit training signals using the selected transmit beam, and the STA 104 may scan receive beams of the receiver codebook. The second stage of the beam search procedure may be referred to as a receiver SLS. The two-stage beam training scheme may have a smaller training overhead of |W|+|F|, or performing a quantity of beam sweeps equal to the sum of the quantity of beams in the receiver codebook and the quantity of beams in the transmitter codebook.

The STA 104 and the AP 102 may support an enhanced two-stage beam search procedure where the STA 104 selects multiple beams in the first stage of the beam search procedure. For example, during the first stage or transmitter SLS, the AP 102 may transmit training signals to the STA 104 using each transmit beam in the transmitter codebook, and the STA 104 may receive the training signals using an omni or a quasi-omnidirectional receive beam. The STA 104 may select multiple beams from the transmitter codebook based on measurements of the training signals. The selected beams may correspond a threshold quantity of beams with the highest measurements, such as the 3 or 4 beams with the highest reference signal received power (RSRP) or SINR measurements. In some examples, the STA 104 may transmit feedback, such as SLS feedback, indicating the selected transmit beams. During the second stage or receiver SLS, the STA 104 may select the best transmit-receive beam pair from the multiple good transmit beams and all of the receive beams.

In some examples, the STA 104 may transmit an SLS feedback message 512. The SLS feedback message 512 may indicate an RF chain pair if more than one chain or spatial stream is used, a beamforming direction for a spatial stream, a best transmit beam, a best receive beam, or any combination thereof. The STA 104 may transmit the SLS feedback message 512 to the AP 102 over the second link 504 or to the AP 102 over the first link 502. In some examples, the second link 504 may support uplink signaling, and the STA 104 may transmit training signals 514 over the second link 504 to the AP 102 after a SIFS from the SLS feedback message 512.

In some examples of the signaling diagram 500, the STA 104 may support multiple spatial streams over the second link 504 to increase a peak data rate over the second link 504. For example, the STA 104 may communicate with the AP 102 over the second link 504 via a first spatial stream and a second spatial stream.

The STA 104 and the AP 102 may perform a multi-stream beam training procedure to select an RF chain pair for each spatial stream and select a beamforming direction for each spatial stream. Each spatial stream may be formed between a transmit RF chain of the AP 102 and a receive RF chain of the STA 104. For example, the STA and the AP 102 use two spatial streams for communications over the second link 504, the AP 102 may have two transmit RF chains (such as ANT_TX1 and ANT_TX2), and the STA 104 may have two receive RF chains (such as ANT_RX1 and ANT_RX2). The multi-stream beam training procedure may select between pairing ANT_TX1 with ANT_RX1 and ANT_TX2 with ANT_RX2 or pairing ANT_TX1 with ANT_RX2 and ANT_TX2 with ANT_RX1. The multi-stream beam training procedure also may identify beamforming directions for each spatial stream. In some examples, the multi-stream beam training procedure may implement aspects of the enhanced two-stage beam search procedure to identify RF chain pairs for spatial streams or to identify beamforming directions for the spatial streams, or both.

Using multiple spatial streams may result in inter-stream interference, where signaling of a first spatial stream interferes with signaling of a second spatial stream. For example, if a beamforming direction of the first spatial stream overlaps with a beamforming direction of the second spatial stream, the spatial streams may have inter-stream interference. If the AP 102 transmits using the first spatial stream and the second spatial stream uses the same time and frequency resources, the waveform of the first spatial stream and the waveform of the second spatial stream may collide. Inter-stream interference may result in lower SINR. Selecting similar beam directions at the same time and frequency may result in fewer effective channel paths, reducing channel capacity.

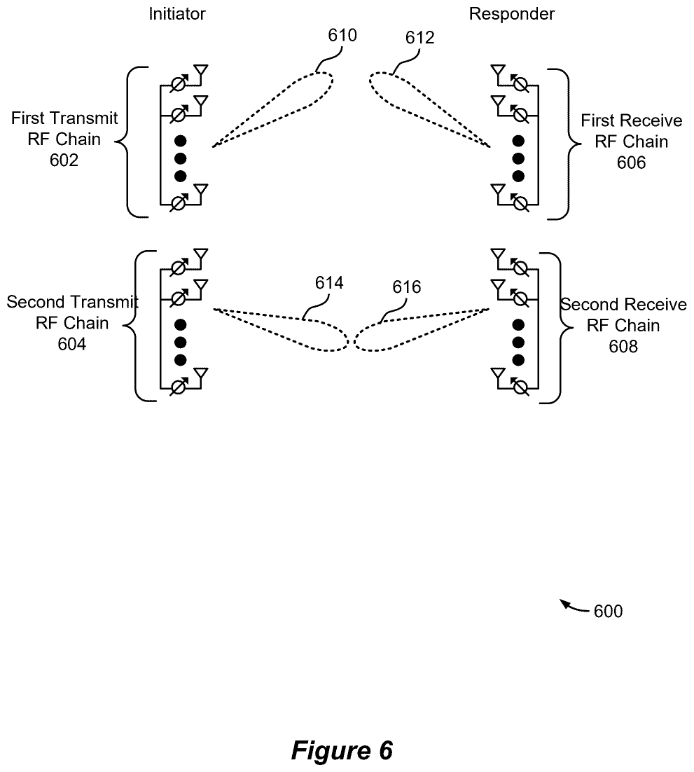

Beam search procedures for multiple spatial streams described herein may provide beam separation while scanning for the best radio frequency chain pairs and best beamforming directions. In some examples, a multi-stream beamforming training procedure may obtain beam separation through antenna polarization. For example, different RF chains or RF chain pairs may use different polarizations, such that signaling of a first spatial stream is orthogonal to signaling of a second spatial stream. Some additional examples of providing beam separation through polarization are described in more detail with reference to FIG. 6. In some examples, a multi-stream beamforming training procedure may obtain beam separation through antenna orientation. For example, transmit RF chains at the AP 102 may be allocated or assigned mutually exclusive beam search regions.

In some examples, a multi-stream beamforming training procedure may include an iterative or sequential beam selection for each RF chain. For example, during a first step, a first RF chain may perform a single beam training procedure to identify a first beam for a first spatial stream. The single beam training procedure may be referred to as a single-input, single-output (SISO) beam search. In some examples, the enhanced two-stage beam search procedure may be an example of the single beam training procedure or SISO beam search.

For the sequential beam search, after selecting the first beam, a second RF chain may perform a single beam training procedure to select a second beam, but the single beam training procedure for the second beam may exclude any directions that overlap with the first beam. For example, the AP 102 and the STA 104 may perform a SISO beam search on the angle-of-interest, excluding directions within a beamwidth of the first beam. The sequential beam search may support up to n beams, where a beam search of RF chain n applies a SISO beam search on the angle of interest excluding directions within beam widths of beams 1 through n−1. In some examples, the STA 104 may transmit a feedback message indicating a selected beam or beamforming direction after each iteration or all iterations of the sequential beam search.

In some examples, the STA 104 and the AP 102 may use multiple different techniques to provide beam separation for a single MIMO beamforming training procedure. For example, the STA 104 and the AP 102 may perform a multi-stream beamforming training procedure which uses antenna polarization and antenna orientation. Additionally, or alternatively, the polarization-separated MIMO beam search techniques may be implemented with the sequential beam search techniques for MIMO beamforming training.

FIG. 6 shows an example of a multi-stream beamforming training 600 that supports beam search procedures for multiple spatial streams.

An initiator wireless communication device of the multi-stream beamforming training 600 may be equipped with multiple RF chains, including at least a first transmit RF chain 602 and a second transmit RF chain 604. An AP 102 may be an example of the initiator wireless communication device. In some examples, the AP 102 may provide a first link (an anchor link) and a second link on a high frequency band. A responder wireless communication device of the multi-stream beamforming training 600 also may be equipped with multiple RF chains, including at least a first receive RF chain 606 and a second receive RF chain 608. A STA 104 may be an example of the responder wireless communication device.

The multi-stream beamforming training 600 may implement techniques to provide beam separation between beams during a multi-stream beamforming training procedure. For example, the multi-stream beamforming training procedure may obtain beam separation through antenna polarization. Different RF chains may use, or be allocated to, different antenna polarizations. For example, the first transmit RF chain 602 may transmit with horizontal polarization, and the second transmit RF chain 604 may transmit with vertical polarization.

The first transmit RF chain 602 and the second transmit RF chain 604 may scan simultaneously over multiple transmit beam directions using different training sequences. For example, the first transmit RF chain 602 and the second transmit RF chain 604 may scan simultaneously over all possible transmit beam directions. In some examples, the first transmit RF chain 602 and the second transmit RF chain 604 may use different training sequences and different polarizations. After the first transmit RF chain 602 and the second transmit RF chain 604 scan over all possible transmit beam directions, the first receive RF chain 606 and the second receive RF chain 608 may scan. In some examples, the scanning for the transmit RF chains may correspond to a first stage of an enhanced two-stage beam search procedure (such as exhaustively scanning all transmit beam directions), and the scanning for the receive RF chains may correspond to a second stage of the enhanced two-stage beam search procedure. For example, the first receive RF chain 606 and the second receive RF chain 608 may scan over all possible receive beam direction for a subset of transmit beam directions.

The responder wireless communication device may record measurements of all possible combinations of radiofrequency chain pairs. For example, the responder wireless communication device may generate a MIMO matrix including four groups of measurement values for the four possible combinations of RF chain pairs. Each element in the MIMO matrix may correspond to a group of measurements obtained from a SISO beamforming procedure between a transmit RF chain of the initiator and a receive RF chain of the responder. For example, a first element in the MIMO matrix may be RSRPs of a SISO beam search for an RF chain pair including the first transmit RF chain 602 and the first receive RF chain 606.

The MIMO matrix may include comprehensive measurements of RF chain pairs. For example, a second element in the MIMO matrix may be for an RF chain pair including the first transmit RF chain 602 and the second receive RF chain 608. A third element for the MIMO matrix may be for an RF chain pair including the second transmit RF chain 604 and the first receive RF chain 606. A fourth element in the MIMO matrix may be for an RF chain pair including the second transmit RF chain 604 and the second receive RF chain 608.

In some other examples, such as if the initiator and responder are establishing additional spatial streams (such as more than two spatial streams), the responder may generate a MIMO matrix including measurements for all possible RF chain pairs. For example, if there are four transmit RF chains and four receive RF chains, and the initiator and responder are establishing four spatial streams, the responder may generate a MIMO matrix including measurements for sixteen different RF chain pairs, or all possible RF chain pairs between the transmit RF chains of the initiator and the receive RF chains of the responder. The responder may identify the highest receive power and the corresponding best beam pair for each element of the MIMO matrix.

The responder may select an RF chain pair for each spatial stream and a corresponding best beam direction for each spatial stream. For example, when using a multi-stream beamforming training procedure that provides beam separation through antenna polarization, the initiator and the responder may select two RF chain pairs for two spatial streams. In a first option, the first transmit RF chain 602 may transmit to the first receive RF chain 606, and the second transmit RF chain 604 may transmit to the second receive RF chain 608. In a second option, the first transmit RF chain 602 may transmit to the second receive RF chain 608, and the second transmit RF chain 604 may transmit to the first receive RF chain 606. The responder may determine whether the first option or the second option has a higher sum of power measurements. In some examples, the power measurements may be, for example, SINR measurements or received power measurements.

The responder may select either the RF chain pairs of either the first option or the second options as the RF chain pairs for the spatial streams based on the measurements. For example, the responder may select the first option for the RF chain pairs, where the first transmit RF chain 602 and the first receive RF chain 606 may be used for a first spatial stream, and the second transmit RF chain 604 and the second receive RF chain 608 may be used for a second spatial stream.

The responder may select beamforming directions for each spatial stream. For example, the responder may select a first beamforming direction for the first spatial stream, and the responder may select a second beamforming direction for the second spatial stream. The responder may identify a first beamforming direction for a first transmit beam 610 formed by the first transmit RF chain 602 and a second beamforming direction for a first receive beam 612 formed by the first receive RF chain 606. The responder may identify a third beamforming direction for a second transmit beam 614 formed by the second transmit RF chain 604 and a fourth beamforming direction for a second receive beam 616 formed by the second receive RF chain 608. The responder may select the beamforming directions based on the measurements of the training signals over all of the possible transmit beam directions.

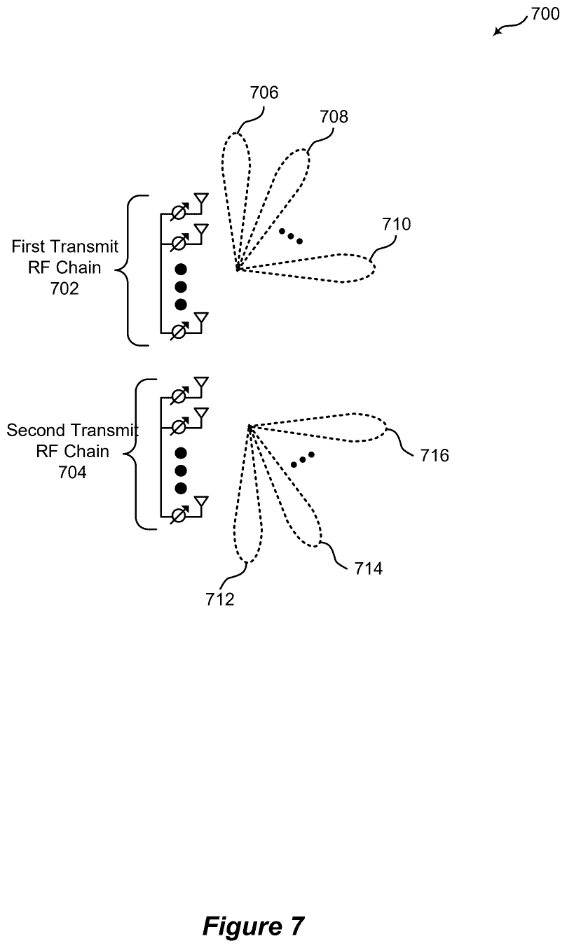

FIG. 7 shows an example of a multi-stream beamforming training 700 that supports beam search procedures for multiple spatial streams.

An initiator wireless communication device of the multi-stream beamforming training 700 may be equipped with multiple RF chains, including at least a first transmit RF chain 702 and a second transmit RF chain 704. An AP 102 may be an example of the initiator wireless communication device. A responder wireless communication device also may be equipped with multiple RF chains, such as a first receive RF chain and a second receive RF chain, which may be used to receive training signals during the multi-stream beamforming training 700. A STA 104 may be an example of the responder wireless communication device.

The multi-stream beamforming training 700 may implement techniques to provide beam separation between beams during a multi-stream beamforming training procedure. For example, the multi-stream beamforming training procedure may obtain beam separation through antenna orientation. Different RF chains may use, or be allocated to, beamforming directions within mutually exclusive beam search regions. The first transmit RF chain 702 may be used for a beam search within a first region, and the second transmit RF chain 704 may be used for a beam search within a second region that is mutually exclusive with the first region. For example, an angle of interest for the multi-stream beamforming training 700 may span

$$[ - \frac{π}{2} , + \frac{π}{2} ] .$$

The first transmit RF and the chain may be allocated an angular region of the angle of interest from

$$( 0 , + \frac{π}{2} ] ,$$

and the second transmit RF chain may be allocated an angular region of the angle of interest from

$$[ - \frac{π}{2} , 0 ] .$$

The first transmit RF chain 702 and the second transmit RF chain 704 may scan simultaneously over the respectively assigned subsets of transmit beam directions. For example, the first transmit RF chain 702 may scan over the first beam search region, and, at the same time, the second transmit RF chain 704 may scan over the second beam search region. For example, the first transmit RF chain 702 may transmit a first training signal using beam 706, a second training signal using beam 708, through sending an Mth training signal using beam 710. The second transmit RF chain 704 may transmit a first training signal using beam 712, a second training signal using beam 714, through sending an Mth training signal using beam 716. In some other examples, different orders of beams or different beam search region may be used.

After the first transmit RF chain 702 and the second transmit RF chain 704 scan over the assigned subset of transmit beam directions, the responder wireless communication device may perform beam scanning for the receive RF chains of the responder wireless communication device. The responder wireless communication device may record measurements of all possible combinations of radiofrequency chain pairs. For example, the responder wireless communication device may generate a MIMO matrix including measurement values for the all possible combinations of RF chain pairs as described in more detail with reference to FIG. 6. Each element in the MIMO matrix may correspond to a group of measurements obtained from a SISO beamforming procedure between a transmit RF chain of the initiator and a receive RF chain of the responder. The responder may select an RF chain pair for each spatial stream and a corresponding best beam direction for each spatial stream based on the measurements.

An orientation-separated beam search may support more than two spatial streams. For example, an angle of interest (such as a 180 degree phase angle allowed for the initiator antennas and the responder antennas) may be divided into four sub-regions. Four transmit RF chains of the initiator wireless communication device may be assigned beamforming directions within 45 degrees segments for a beam search.

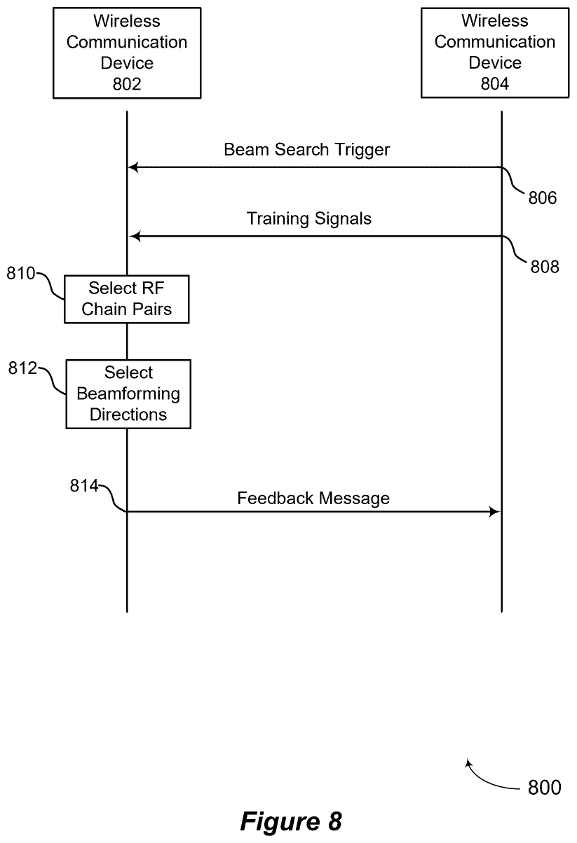

FIG. 8 shows an example of a process flow 800 that supports beam search procedures for multiple spatial streams. The process flow 800 may implement aspects of wireless communication network 100. For instance, the process flow 800 may illustrate operations between a wireless communication device 802 and a wireless communication device 804. The wireless communication device 802 may be an example of a STA 104, and the wireless communication device 804 may be an example of an AP 102. In the following description of the process flow 800, the operations between the wireless communication device 802 and the wireless communication device 804 may be transmitted in a different order than the example order shown, or the operations performed by the wireless communication device 802 and the wireless communication device 804 may be performed in different orders or at different times. Some operations also may be omitted from the process flow 800, and other operations may be added to the process flow 800.

At 806, the wireless communication device 802 may receive a beam search trigger. For example, wireless communication device 802 may receive, via a first link in a first radio frequency spectrum band, a beam search trigger for a second link in a second radio frequency spectrum band. In some examples, the wireless communication device 804 may transmit the beam search trigger to the wireless communication device 802. For example, the wireless communication device 804 may provide the first link (an anchor link) in the first radio frequency spectrum band and the second link in the second radio frequency spectrum band (a high frequency band).

At 808, the wireless communication device 804 may transmit training signals to the wireless communication device 802. For example, the wireless communication device 802 may receive, over the second link via multiple receive radio frequency chains, multiple training signals from multiple transmit radio frequency chains of the wireless communication device 804 in accordance with the beam search trigger.

The wireless communication device 804 may transmit the training signals with some separation between beams for the beam search procedure. For example, the beam search procedure may have separation between beams based on antenna polarization, antenna orientation, or selecting non-overlapping beams (such as using a sequential beam search), or any combination thereof.

For example, the beam search procedure may use antenna polarization for beam separation. The wireless communication device 802 may receive, over the second link via a first receive radio frequency chain having a first polarization, a first set of training signals from a first transmit radio frequency chain with the first polarization. The wireless communication device 802 may receive, via the first receive RF chain and simultaneous to the first set of training signals, a second set of training signals from a second transmit radio frequency chain with a second polarization. The wireless communication device 802 may receive the first set of training signals and the second set of training signals over each beamforming direction of a set of beamforming directions (such as all possible beamforming directions) in accordance with the beam search trigger.

The wireless communication device 802 may receive, over the second link via a second receive RF chain having the second polarization, the first set of training signals from the first transmit RF chain with the first polarization and, simultaneous to the first set of training signals, the second set of training signals from the second transmit RF chain with the second polarization. The wireless communication device 802 may receive the first set of training signals and the second set of training signals over each beamforming direction of the set of beamforming directions in accordance with the beam search trigger.

In some examples, the beam search procedure may use antenna orientation for beam separation. The wireless communication device 802 may receive, over the second link via a first receive RF chain, a first set of training signals from a first transmit RF chain and a second set of training signals from a second transmit RF chain in accordance with the beam search trigger. The wireless communication device 804 may transmit the first set of training signals over a first subset of beamforming directions, and the wireless communication device 804 may transmit the second set of training signals over a second subset of beamforming directions that is non-overlapping with the first subset of beamforming directions. The wireless communication device 802 may receive, over the second link via a second receive RF chain of the set of receive RF chains, the first set of training signals from the first transmit RF chain and the second set of training signals from the second transmit RF chain in accordance with the beam search trigger.

At 810, the wireless communication device 802 may select RF chain pairs for spatial streams. For example, the wireless communication device 802 may select a set of RF chain pairs for a set of spatial streams in accordance with the training signals. The wireless communication device 802 may select an RF chain pair for each spatial stream of the set of spatial streams in accordance with the training signals. In some examples, each RF chain pair of the set of RF chain pairs may include a receive RF chain of the multiple receive RF chains and a transmit RF chain of the multiple transmit RF chains.

At 812, the wireless communication device 802 may select a set of beamforming directions for the set of spatial streams in accordance with the training signals. The wireless communication device 802 may select a beamforming direction for each spatial stream of the set of spatial streams in accordance with the training signals. In some examples, at 814, the wireless communication device 802 may transmit a feedback message (such as an SLS feedback message), to the wireless communication device 804. The feedback message may indicate the set of RF chain pairs or the set of beamforming directions, or both.

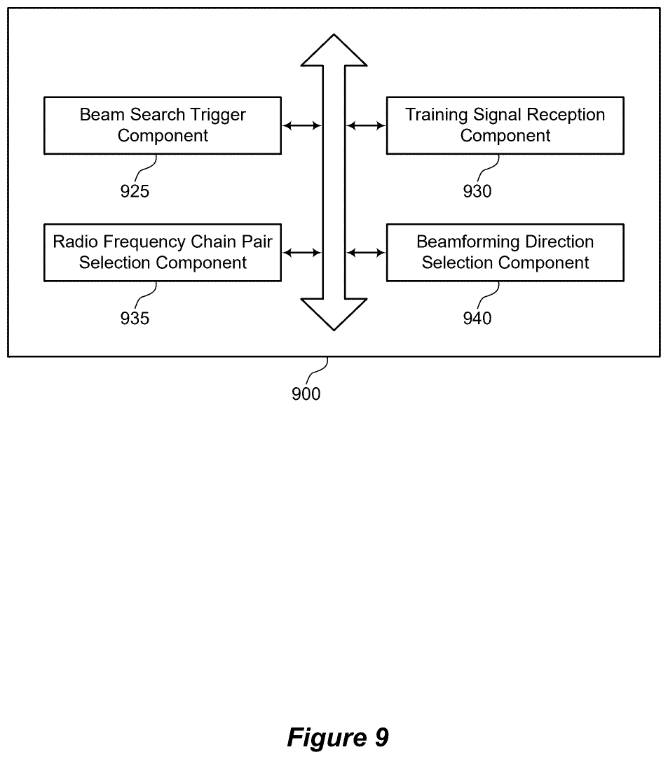

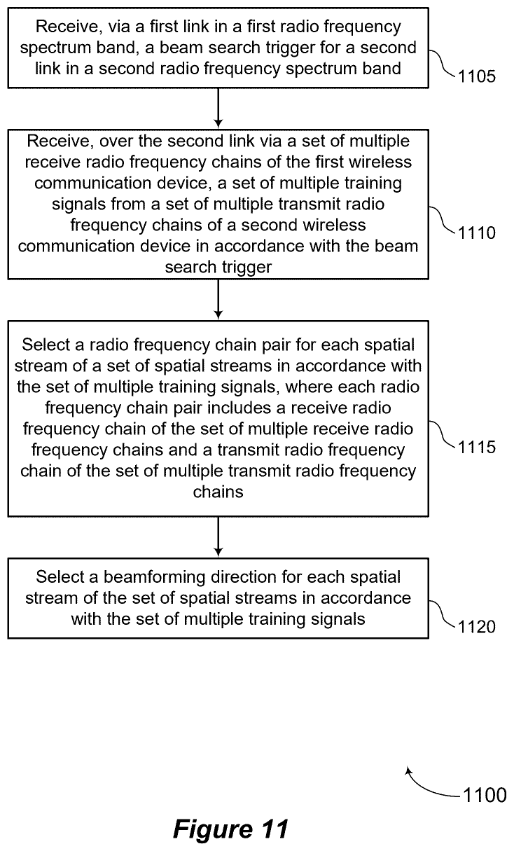

FIG. 9 shows a block diagram of an example wireless communication device 900 that supports beam search procedures for multiple spatial streams. In some examples, the wireless communication device 900 is configured to perform the process 1100 described with reference to FIG. 11. The wireless communication device 900 may include one or more chips, SoCs, chipsets, packages, components or devices that individually or collectively constitute or include a processing system. The processing system may interface with other components of the wireless communication device 900, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 900 may transmit the information output from the chip. In such an example, the second interface may refer to an interface between the processing system of the chip and a reception component, such that the wireless communication device 900 may receive information that is then passed to the processing system. In some such examples, the first interface also may obtain information, such as from the transmission component, and the second interface also may output information, such as to the reception component.

The processing system of the wireless communication device 900 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 900 can be configurable or configured for use in a STA, such as the STA 104 described with reference to FIG. 1. In some other examples, the wireless communication device 900 can be a STA that includes such a processing system and other components including multiple antennas. The wireless communication device 900 is capable of transmitting and receiving wireless communications in the form of, for example, wireless packets. For example, the wireless communication device 900 can be configurable or configured to transmit and receive packets in the form of physical layer PPDUs and MPDUs conforming to one or more of the IEEE 802.11 family of wireless communication protocol standards. In some other examples, the wireless communication device 900 can be configurable or configured to transmit and receive signals and communications conforming to one or more 3GPP specifications including those for 5G NR or 6G. In some examples, the wireless communication device 900 also includes or can be coupled with one or more application processors which may be further coupled with one or more other memories. In some examples, the wireless communication device 900 further includes a user interface (UI) (such as a touchscreen or keypad) and a display, which may be integrated with the UI to form a touchscreen display that is coupled with the processing system. In some examples, the wireless communication device 900 may further include one or more sensors such as, for example, one or more inertial sensors, accelerometers, temperature sensors, pressure sensors, or altitude sensors, which are coupled with the processing system.

The wireless communication device 900 includes a beam search trigger component 925, a training signal reception component 930, a radio frequency chain pair selection component 935, and a beamforming direction selection component 940. Portions of one or more of the beam search trigger component 925, the training signal reception component 930, the radio frequency chain pair selection component 935, and the beamforming direction selection component 940 may be implemented at least in part in hardware or firmware. For example, one or more of the beam search trigger component 925, the training signal reception component 930, the radio frequency chain pair selection component 935, and the beamforming direction selection component 940 may be implemented at least in part by at least a processor or a modem. In some examples, portions of one or more of the beam search trigger component 925, the training signal reception component 930, the radio frequency chain pair selection component 935, and the beamforming direction selection component 940 may be implemented at least in part by a processor and software in the form of processor-executable code stored in memory.

The wireless communication device 900 may support wireless communication in accordance with examples as disclosed herein. The beam search trigger component 925 is configurable or configured to receive, via a first link in a first radio frequency spectrum band, a beam search trigger for a second link in a second radio frequency spectrum band. The training signal reception component 930 is configurable or configured to receive, over the second link via a set of multiple receive radio frequency chains of the first wireless communication device, a set of multiple training signals from a set of multiple transmit radio frequency chains of a second wireless communication device in accordance with the beam search trigger. The radio frequency chain pair selection component 935 is configurable or configured to select a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains. The beamforming direction selection component 940 is configurable or configured to select a beamforming direction for each spatial stream of the set of spatial streams in accordance with the set of multiple training signals.

In some examples, to support receiving the set of multiple training signals, the training signal reception component 930 is configurable or configured to receive, over the second link via a first receive radio frequency chain of the set of multiple receive radio frequency chains, the first receive radio frequency chain having a first polarization, a first set of multiple training signals from a first transmit radio frequency chain with the first polarization and, simultaneous to the first set of multiple training signals, a second set of multiple training signals from a second transmit radio frequency chain with a second polarization, the first set of multiple training signals and the second set of multiple training signals received over each beamforming direction of a set of multiple beamforming directions in accordance with the beam search trigger. In some examples, to support receiving the set of multiple training signals, the training signal reception component 930 is configurable or configured to receive, over the second link via a second receive radio frequency chain of the set of multiple receive radio frequency chains, the second receive radio frequency chain having the second polarization, the first set of multiple training signals from the first transmit radio frequency chain with the first polarization and, simultaneous to the first set of multiple training signals, the second set of multiple training signals from the second transmit radio frequency chain with the second polarization, the first set of multiple training signals and the second set of multiple training signals received over each beamforming direction of the set of multiple beamforming directions in accordance with the beam search trigger.

In some examples, to support selecting the set of radio frequency chain pairs, the radio frequency chain pair selection component 935 is configurable or configured to select a first radio frequency chain pair for a first spatial stream and a second radio frequency chain pair for a second spatial stream in accordance with receiving the first set of multiple training signals and the second set of multiple training signals.

In some examples, to support selecting the set of beamforming directions, the beamforming direction selection component 940 is configurable or configured to select a first beamforming direction from the set of multiple beamforming directions for a first spatial stream and a second beamforming direction from the set of multiple beamforming directions for a second spatial stream in accordance with receiving the first set of multiple training signals via the first radio frequency chain pair and the second set of multiple training signals via the second radio frequency chain pair.

In some examples, the radio frequency chain pair selection component 935 is configurable or configured to measure a first received power for a first radio frequency chain pair including the first transmit radio frequency chain and the first receive radio frequency chain, a second received power for a second radio frequency chain pair including the second transmit radio frequency chain and the second receive radio frequency chain, a third received power for a third radio frequency chain pair including the first transmit radio frequency chain and the second receive radio frequency chain, and a fourth received power for a fourth radio frequency chain pair including the second transmit radio frequency chain and the first receive radio frequency chain in accordance with receiving the first set of multiple training signals and the second set of multiple training signals.

In some examples, the first radio frequency chain pair and the second radio frequency chain pair are selected according to a first sum of the first received power and the second received power being greater than a second sum of the third received power and the fourth received power.

In some examples, to support receiving the set of multiple training signals, the training signal reception component 930 is configurable or configured to receive, over the second link via a first receive radio frequency chain of the set of multiple receive radio frequency chains, a first set of multiple training signals from a first transmit radio frequency chain and a second set of multiple training signals from a second transmit radio frequency chain in accordance with the beam search trigger, the first set of multiple training signals transmitted over a first subset of beamforming directions and the second set of multiple training signals transmitted over a second subset of beamforming directions that is non-overlapping with the first subset of beamforming directions. In some examples, to support receiving the set of multiple training signals, the training signal reception component 930 is configurable or configured to receive, over the second link via a second receive radio frequency chain of the set of multiple receive radio frequency chains, the first set of multiple training signals from the first transmit radio frequency chain and the second set of multiple training signals from the second transmit radio frequency chain in accordance with the beam search trigger, the first set of multiple training signals transmitted over the first subset of beamforming directions and the second set of multiple training signals transmitted over the second subset of beamforming directions.

In some examples, to support selecting the set of radio frequency chain pairs, the radio frequency chain pair selection component 935 is configurable or configured to select a first radio frequency chain pair for a first spatial stream and a second radio frequency chain pair for a second spatial stream in accordance with receiving the first set of multiple training signals and the second set of multiple training signals.

In some examples, to support selecting the set of beamforming directions, the beamforming direction selection component 940 is configurable or configured to select a first beamforming direction from the first subset of beamforming directions or the second subset of beamforming directions for a first spatial stream and a second beamforming direction from the first subset of beamforming directions or the second subset of beamforming directions for a second spatial stream in accordance with receiving the first set of multiple training signals via the first radio frequency chain pair and the second set of multiple training signals via the second radio frequency chain pair.

In some examples, the first set of multiple training signals are polarized according to a first polarization, and the second set of multiple training signals are polarized according to a second polarization.

In some examples, to support receiving the set of multiple training signals, the training signal reception component 930 is configurable or configured to receive, over the second link via a first receive radio frequency chain, a first set of multiple training signals over a set of multiple beamforming directions in accordance with the beam search trigger, and where selecting the set of radio frequency chain pairs includes. In some examples, to support receiving the set of multiple training signals, the beamforming direction selection component 940 is configurable or configured to select a first beamforming direction from the set of multiple beamforming directions for a first beam of a first spatial stream in accordance with receiving the first set of multiple training signals.

In some examples, to support receiving the set of multiple training signals, the training signal reception component 930 is configurable or configured to receive, over the second link via a second receive radio frequency chain, a second set of multiple training signals over the set of multiple beamforming directions excluding a subset of beamforming directions within a beam width of the first beam in accordance with the beam search trigger; and where selecting the set of radio frequency chain pairs includes. In some examples, to support receiving the set of multiple training signals, the beamforming direction selection component 940 is configurable or configured to select a second beamforming direction from the set of multiple beamforming directions for a second beam of a second spatial stream in accordance with receiving the second set of multiple training signals.

In some examples, the beamforming direction selection component 940 is configurable or configured to transmit, via the first link or the second link, a feedback message indicating the set of radio frequency chain pairs and the set of beamforming directions.

In some examples, the radio frequency chain pair selection component 935 is configurable or configured to measure a received power for all combinations of radio frequency chain pairs between the set of multiple receive radio frequency chains and the set of multiple transmit radio frequency chains, where the set of radio frequency chain pairs have a highest combined received power of all combinations of radio frequency chain pairs having a same quantity of radio frequency chain pairs as the set of radio frequency chain pairs.

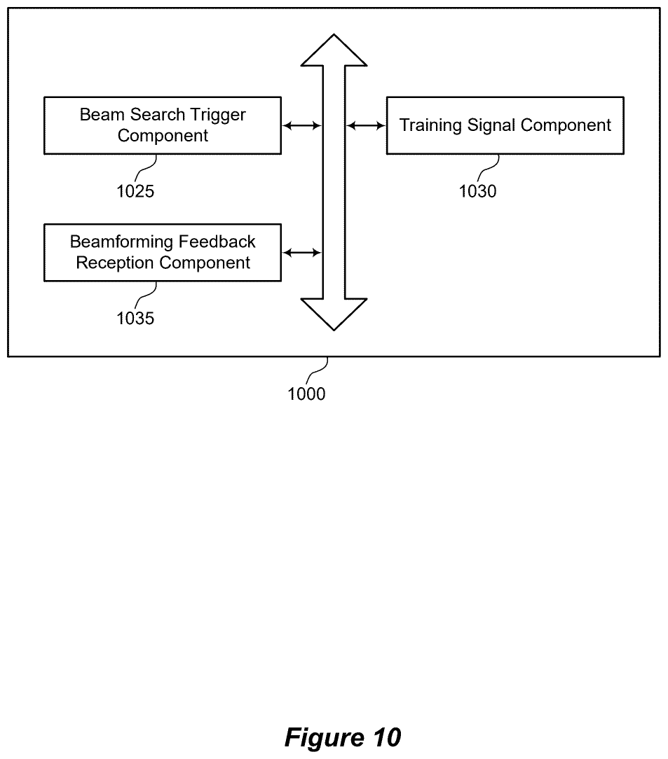

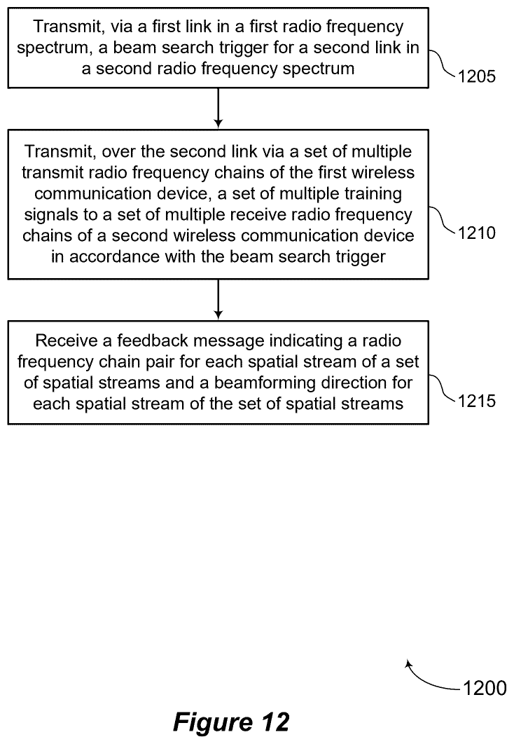

FIG. 10 shows a block diagram of an example wireless communication device 1000 that supports beam search procedures for multiple spatial streams. In some examples, the wireless communication device 1000 is configured to perform the process 1200 described with reference to FIG. 12. The wireless communication device 1000 may include one or more chips, SoCs, chipsets, packages, components or devices that individually or collectively constitute or include a processing system. The processing system may interface with other components of the wireless communication device 1000, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 1000 may transmit the information output from the chip. In such an example, the second interface may refer to an interface between the processing system of the chip and a reception component, such that the wireless communication device 1000 may receive information that is then passed to the processing system. In some such examples, the first interface also may obtain information, such as from the transmission component, and the second interface also may output information, such as to the reception component.

The processing system of the wireless communication device 1000 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (such as IEEE compliant) modem or a cellular (such as 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1000 can be configurable or configured for use in an AP, such as the AP 102 described with reference to FIG. 1. In some other examples, the wireless communication device 1000 can be an AP that includes such a processing system and other components including multiple antennas. The wireless communication device 1000 is capable of transmitting and receiving wireless communications in the form of, for example, wireless packets. For example, the wireless communication device 1000 can be configurable or configured to transmit and receive packets in the form of physical layer PPDUs and MPDUs conforming to one or more of the IEEE 802.11 family of wireless communication protocol standards. In some other examples, the wireless communication device 1000 can be configurable or configured to transmit and receive signals and communications conforming to one or more 3GPP specifications including those for 5G NR or 6G. In some examples, the wireless communication device 1000 also includes or can be coupled with one or more application processors which may be further coupled with one or more other memories. In some examples, the wireless communication device 1000 further includes at least one external network interface coupled with the processing system that enables communication with a core network or backhaul network that enables the wireless communication device 1000 to gain access to external networks including the Internet.

The wireless communication device 1000 includes a beam search trigger component 1025, a training signal component 1030, and a beamforming feedback component 1035. Portions of one or more of the beam search trigger component 1025, the training signal component 1030, and the beamforming feedback component 1035 may be implemented at least in part in hardware or firmware. For example, one or more of the beam search trigger component 1025, the training signal component 1030, and the beamforming feedback component 1035 may be implemented at least in part by at least a processor or a modem. In some examples, portions of one or more of the beam search trigger component 1025, the training signal component 1030, and the beamforming feedback component 1035 may be implemented at least in part by a processor and software in the form of processor-executable code stored in memory.

The wireless communication device 1000 may support wireless communication in accordance with examples as disclosed herein. The beam search trigger component 1025 is configurable or configured to transmit, via a first link in a first radio frequency spectrum, a beam search trigger for a second link in a second radio frequency spectrum. The training signal component 1030 is configurable or configured to transmit, over the second link via a set of multiple transmit radio frequency chains of the first wireless communication device, a set of multiple training signals to a set of multiple receive radio frequency chains of a second wireless communication device in accordance with the beam search trigger. The beamforming feedback reception component 1035 is configurable or configured to receive a feedback message indicating a radio frequency chain pair for each spatial stream of a set of spatial streams and a beamforming direction for each spatial stream of the set of spatial streams.

In some examples, to support transmitting the set of multiple training signals, the training signal component 1030 is configurable or configured to transmit a first set of multiple training signals over a set of multiple beamforming directions via a first transmit radio frequency chain with a first polarization in accordance with the beam search trigger. In some examples, to support transmitting the set of multiple training signals, the training signal component 1030 is configurable or configured to transmit a second set of multiple training signals over the set of multiple beamforming directions via a second transmit radio frequency chain with a second polarization in accordance with the beam search trigger.

In some examples, to support transmitting the set of multiple training signals, the training signal component 1030 is configurable or configured to transmit a first set of multiple training signals over a first subset of beamforming directions via a first transmit radio frequency chain in accordance with the beam search trigger. In some examples, to support transmitting the set of multiple training signals, the training signal component 1030 is configurable or configured to transmit a second set of multiple training signals over a second subset of beamforming directions that is non-overlapping with the first subset of beamforming directions via a second transmit radio frequency chain in accordance with the beam search trigger.

In some examples, to support transmitting the set of multiple training signals, the training signal component 1030 is configurable or configured to transmit, via a first transmit radio frequency chain, a first set of multiple training signals over a set of multiple beamforming directions in accordance with the beam search trigger, where the feedback message indicates a first beam direction a first spatial stream, the first beam direction associated with a first beam having a first beam width. In some examples, to support receiving the set of multiple training signals, the training signal component 1030 is configurable or configured to transmit, via a second transmit radio frequency chain, a second set of multiple training signals over the set of multiple beamforming directions excluding a subset of beamforming directions within the first beam width of the first beam in accordance with the beam search trigger and the feedback message.

FIG. 11 shows a flowchart illustrating an example process 1100 performable by or at a first wireless communication device that supports beam search procedures for multiple spatial streams. The operations of the process 1100 may be implemented by a first wireless communication device or its components as described herein. For example, the process 1100 may be performed by a wireless communication device, such as the wireless communication device 900 described with reference to FIG. 9, operating as or within a wireless STA. In some examples, the process 1100 may be performed by a wireless STA, such as one of the STAs 104 described with reference to FIG. 1.

In some examples, in block 1105, the first wireless communication device may receive, via a first link in a first radio frequency spectrum band, a beam search trigger for a second link in a second radio frequency spectrum band. The operations of block 1105 may be performed in accordance with examples as disclosed herein. In some implementations, aspects of the operations of block 1105 may be performed by a beam search trigger component 925 as described with reference to FIG. 9.

In some examples, in block 1110, the first wireless communication device may receive, over the second link via a set of multiple receive radio frequency chains of the first wireless communication device, a set of multiple training signals from a set of multiple transmit radio frequency chains of a second wireless communication device in accordance with the beam search trigger. The operations of block 1110 may be performed in accordance with examples as disclosed herein. In some implementations, aspects of the operations of block 1110 may be performed by a training signal reception component 930 as described with reference to FIG. 9.

In some examples, in block 1115, the first wireless communication device may select a radio frequency chain pair for each spatial stream of a set of spatial streams in accordance with the set of multiple training signals, where each radio frequency chain pair includes a receive radio frequency chain of the set of multiple receive radio frequency chains and a transmit radio frequency chain of the set of multiple transmit radio frequency chains. The operations of block 1115 may be performed in accordance with examples as disclosed herein. In some implementations, aspects of the operations of block 1115 may be performed by a radio frequency chain pair selection component 935 as described with reference to FIG. 9.

In some examples, in block 1120, the first wireless communication device may select a beamforming direction for each spatial stream of the set of spatial streams in accordance with the set of multiple training signals. The operations of block 1120 may be performed in accordance with examples as disclosed herein. In some implementations, aspects of the operations of block 1120 may be performed by a beamforming direction selection component 940 as described with reference to FIG. 9.

FIG. 12 shows a flowchart illustrating an example process 1200 performable by or at a first wireless communication device that supports beam search procedures for multiple spatial streams. The operations of the process 1200 may be implemented by a first wireless communication device or its components as described herein. For example, the process 1200 may be performed by a wireless communication device, such as the wireless communication device 1000 described with reference to FIG. 10, operating as or within a wireless AP. In some examples, the process 1200 may be performed by a wireless AP, such as one of the APs 102 described with reference to FIG. 1.

In some examples, in block 1205, the first wireless communication device may transmit, via a first link in a first radio frequency spectrum, a beam search trigger for a second link in a second radio frequency spectrum. The operations of block 1205 may be performed in accordance with examples as disclosed herein. In some implementations, aspects of the operations of block 1205 may be performed by a beam search trigger component 1025 as described with reference to FIG. 10.

In some examples, in block 1210, the first wireless communication device may transmit, over the second link via a set of multiple transmit radio frequency chains of the first wireless communication device, a set of multiple training signals to a set of multiple receive radio frequency chains of a second wireless communication device in accordance with the beam search trigger. The operations of block 1210 may be performed in accordance with examples as disclosed herein. In some implementations, aspects of the operations of block 1210 may be performed by a training signal component 1030 as described with reference to FIG. 10.

In some examples, in block 1215, the first wireless communication device may receive a feedback message indicating a radio frequency chain pair for each spatial stream of a set of spatial streams and a beamforming direction for each spatial stream of the set of spatial streams. The operations of block 1215 may be performed in accordance with examples as disclosed herein. In some implementations, aspects of the operations of block 1215 may be performed by a beamforming feedback component 1035 as described with reference to FIG. 10.

Implementation examples are described in the following numbered clauses:

The following provides an overview of aspects of the present disclosure:

Aspect 1: A method for wireless communication by a first wireless communication device, comprising: receiving, via a first link in a first radio frequency spectrum band, a beam search trigger for a second link in a second radio frequency spectrum band; receiving, over the second link via a plurality of receive radio frequency chains of the first wireless communication device, a plurality of training signals from a plurality of transmit radio frequency chains of a second wireless communication device in accordance with the beam search trigger; selecting a radio frequency chain pair for each spatial stream of a set of spatial streams in accordance with the plurality of training signals, wherein each radio frequency chain pair o comprises a receive radio frequency chain of the plurality of receive radio frequency chains and a transmit radio frequency chain of the plurality of transmit radio frequency chains; and selecting a beamforming direction for each spatial stream of the set of spatial streams in accordance with the plurality of training signals.

Aspect 2: The method of aspect 1, wherein receiving the plurality of training signals comprises: receiving, over the second link via a first receive radio frequency chain of the plurality of receive radio frequency chains, the first receive radio frequency chain having a first polarization, a first plurality of training signals from a first transmit radio frequency chain with the first polarization and, simultaneous to the first plurality of training signals, a second plurality of training signals from a second transmit radio frequency chain with a second polarization, the first plurality of training signals and the second plurality of training signals received over each beamforming direction of a plurality of beamforming directions in accordance with the beam search trigger; and receiving, over the second link via a second receive radio frequency chain of the plurality of receive radio frequency chains, the second receive radio frequency chain having the second polarization, the first plurality of training signals from the first transmit radio frequency chain with the first polarization and, simultaneous to the first plurality of training signals, the second plurality of training signals from the second transmit radio frequency chain with the second polarization, the first plurality of training signals and the second plurality of training signals received over each beamforming direction of the plurality of beamforming directions in accordance with the beam search trigger.

Aspect 3: The method of aspect 2, wherein selecting the radio frequency chain pair for each spatial stream comprises: selecting a first radio frequency chain pair for a first spatial stream and a second radio frequency chain pair for a second spatial stream in accordance with receiving the first plurality of training signals and the second plurality of training signals.

Aspect 4: The method of any of aspects 2 through 3, wherein selecting the beamforming direction for each spatial stream comprises: selecting a first beamforming direction from the plurality of beamforming directions for a first spatial stream and a second beamforming direction from the plurality of beamforming directions for a second spatial stream in accordance with receiving the first plurality of training signals via the first radio frequency chain pair and the second plurality of training signals via the second radio frequency chain pair.

Aspect 5: The method of any of aspects 2 through 4, further comprising: measuring a first received power for a first radio frequency chain pair comprising the first transmit radio frequency chain and the first receive radio frequency chain, a second received power for a second radio frequency chain pair comprising the second transmit radio frequency chain and the second receive radio frequency chain, a third received power for a third radio frequency chain pair comprising the first transmit radio frequency chain and the second receive radio frequency chain, and a fourth received power for a fourth radio frequency chain pair comprising the second transmit radio frequency chain and the first receive radio frequency chain in accordance with receiving the first plurality of training signals and the second plurality of training signals.

Aspect 6: The method of aspect 5, wherein the first radio frequency chain pair and the second radio frequency chain pair are selected according to a first sum of the first received power and the second received power being greater than a second sum of the third received power and the fourth received power.

Aspect 7: The method of any of aspects 1 through 6, wherein receiving the plurality of training signals comprises: receiving, over the second link via a first receive radio frequency chain of the plurality of receive radio frequency chains, a first plurality of training signals from a first transmit radio frequency chain and a second plurality of training signals from a second transmit radio frequency chain in accordance with the beam search trigger, the first plurality of training signals transmitted over a first subset of beamforming directions and the second plurality of training signals transmitted over a second subset of beamforming directions that is non-overlapping with the first subset of beamforming directions; and receiving, over the second link via a second receive frequency chain of the plurality of receive radio frequency chains, the first plurality of training signals from the first transmit radio frequency chain and the second plurality of training signals from the second transmit radio frequency chain in accordance with the beam search trigger, the first plurality of training signals transmitted over the first subset of beamforming directions and the second plurality of training signals transmitted over the second subset of beamforming directions.

Aspect 8: The method of aspect 7, wherein selecting the radio frequency chain pair for each spatial stream comprises: selecting a first radio frequency chain pair for a first spatial stream and a second radio frequency chain pair for a second spatial stream in accordance with receiving the first plurality of training signals and the second plurality of training signals.

Aspect 9: The method of any of aspects 7 through 8, wherein selecting the beamforming direction for each spatial stream comprises: selecting a first beamforming direction from the first subset of beamforming directions or the second subset of beamforming directions for a first spatial stream and a second beamforming direction from the first subset of beamforming directions or the second subset of beamforming directions for a second spatial stream in accordance with receiving the first plurality of training signals via the first radio frequency chain pair and the second plurality of training signals via the second radio frequency chain pair.

Aspect 10: The method of any of aspects 7 through 9, wherein the first plurality of training signals are polarized according to a first polarization, and the second plurality of training signals are polarized according to a second polarization.

Aspect 11: The method of any of aspects 1 through 10, wherein receiving the plurality of training signals comprises: receiving, over the second link via a first receive radio frequency chain, a first plurality of training signals over a plurality of beamforming directions in accordance with the beam search trigger, and wherein selecting the radio frequency chain pair for each spatial stream comprises: selecting a first beamforming direction from the plurality of beamforming directions for a first beam of a first spatial stream in accordance with receiving the first plurality of training signals.

Aspect 12: The method of aspect 11, wherein receiving the plurality of training signals comprises: receiving, over the second link via a second receive radio frequency chain, a second plurality of training signals over the plurality of beamforming directions excluding a subset of beamforming directions within a beam width of the first beam in accordance with the beam search trigger; and wherein selecting the radio frequency chain pair for each spatial stream comprises: selecting a second beamforming direction from the plurality of beamforming directions for a second beam of a second spatial stream in accordance with receiving the second plurality of training signals.

Aspect 13: The method of any of aspects 1 through 12, further comprising: transmitting, via the first link or the second link, a feedback message indicating the radio frequency chain pair for each spatial stream and the beamforming direction for each spatial stream.

Aspect 14: The method of any of aspects 1 through 13, further comprising: measuring a received power for all combinations of radio frequency chain pairs between the plurality of receive radio frequency chains and the plurality of transmit radio frequency chains, wherein the selected radio frequency chain pairs have a highest combined received power of all combinations of radio frequency chain pairs having a same quantity of radio frequency chain pairs as the selected radio frequency chain pairs.

Aspect 15: A method for wireless communication by a first wireless communication device, comprising: transmitting, via a first link in a first radio frequency spectrum, a beam search trigger for a second link in a second radio frequency spectrum; transmitting, over the second link via a plurality of transmit radio frequency chains of the first wireless communication device, a plurality of training signals to a plurality of receive radio frequency chains of a second wireless communication device in accordance with the beam search trigger; and receiving a feedback message indicating a radio frequency chain pair for each spatial stream of a set of spatial streams and a beamforming direction for each spatial stream of for the set of spatial streams.

Aspect 16: The method of aspect 15, wherein transmitting the plurality of training signals comprises: transmitting a first plurality of training signals over a plurality of beamforming directions via a first transmit radio frequency chain with a first polarization in accordance with the beam search trigger; and transmitting a second plurality of training signals over the plurality of beamforming directions via a second transmit radio frequency chain with a second polarization in accordance with the beam search trigger.

Aspect 17: The method of any of aspects 15 through 16, wherein transmitting the plurality of training signals comprises: transmitting a first plurality of training signals over a first subset of beamforming directions via a first transmit radio frequency chain in accordance with the beam search trigger; and transmitting a second plurality of training signals over a second subset of beamforming directions that is non-overlapping with the first subset of beamforming directions via a second transmit radio frequency chain in accordance with the beam search trigger.

Aspect 18: The method of any of aspects 15 through 17, wherein transmitting the plurality of training signals comprises: transmitting, via a first transmit radio frequency chain, a first plurality of training signals over a plurality of beamforming directions in accordance with the beam search trigger, wherein the feedback message indicates a first beam direction a first spatial stream, the first beam direction associated with a first beam having a first beam width; and transmitting, via a second transmit radio frequency chain, a second plurality of training signals over the plurality of beamforming directions excluding a subset of beamforming directions within the first beam width of the first beam in accordance with the beam search trigger and the feedback message.

Aspect 19: A first wireless communication device for wireless communication, comprising one or more memories storing processor-executable code, and one or more processors coupled with the one or more memories and individually or collectively operable to execute the code to cause the first wireless communication device to perform a method of any of aspects 1 through 14.

Aspect 20: A first wireless communication device for wireless communication, comprising at least one means for performing a method of any of aspects 1 through 14.

Aspect 21: A non-transitory computer-readable medium storing code for wireless communication, the code comprising instructions executable by one or more processors to perform a method of any of aspects 1 through 14.

Aspect 22: A first wireless communication device for wireless communication, comprising one or more memories storing processor-executable code, and one or more processors coupled with the one or more memories and individually or collectively operable to execute the code to cause the first wireless communication device to perform a method of any of aspects 15 through 18.

Aspect 23: A first wireless communication device for wireless communication, comprising at least one means for performing a method of any of aspects 15 through 18.

Aspect 24: A non-transitory computer-readable medium storing code for wireless communication, the code comprising instructions executable by one or more processors to perform a method of any of aspects 15 through 18. As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless communication device, comprising:
a processing system that includes processor circuitry and memory circuitry that stores code, the processing system configured to cause the first wireless communication device to:
receive, via a first link in a first radio frequency spectrum band, a beam search trigger for a second link in a second radio frequency spectrum band;
receive, over the second link via a plurality of receive radio frequency chains of the first wireless communication device, a plurality of training signals from a plurality of transmit radio frequency chains of a second wireless communication device in accordance with the beam search trigger;
select a radio frequency chain pair for each spatial stream of a set of spatial streams in accordance with the plurality of training signals, wherein each radio frequency chain pair comprises a receive radio frequency chain of the plurality of receive radio frequency chains and a transmit radio frequency chain of the plurality of transmit radio frequency chains; and
select a beamforming direction for each spatial stream of the set of spatial streams in accordance with the plurality of training signals.

2. The first wireless communication device of claim 1, wherein, to receive the plurality of training signals, the processing system is configured to cause the first wireless communication device to:
receive, over the second link via a first receive radio frequency chain of the plurality of receive radio frequency chains, a first plurality of training signals from a first transmit radio frequency chain with a first polarization and, simultaneous to the first plurality of training signals, a second plurality of training signals from a second transmit radio frequency chain with a second polarization different from the first polarization, the first receive radio frequency chain having the first polarization, the first plurality of training signals and the second plurality of training signals received over each beamforming direction of a plurality of beamforming directions in accordance with the beam search trigger; and
receive, over the second link via a second receive radio frequency chain of the plurality of receive radio frequency chains, the first plurality of training signals from the first transmit radio frequency chain with the first polarization and, simultaneous to the first plurality of training signals, the second plurality of training signals from the second transmit radio frequency chain with the second polarization, the second receive radio frequency chain having the second polarization, the first plurality of training signals and the second plurality of training signals received over each beamforming direction of the plurality of beamforming directions in accordance with the beam search trigger.

3. The first wireless communication device of claim 2, wherein, to select the radio frequency chain pair for each spatial stream, the processing system is configured to cause the first wireless communication device to:
select a first radio frequency chain pair for a first spatial stream and a second radio frequency chain pair for a second spatial stream in accordance with receiving the first plurality of training signals and the second plurality of training signals.

4. The first wireless communication device of claim 2, wherein, to select the beamforming direction for each spatial stream, the processing system is configured to cause the first wireless communication device to:
select a first beamforming direction from the plurality of beamforming directions for a first spatial stream and a second beamforming direction from the plurality of beamforming directions for a second spatial stream in accordance with receiving the first plurality of training signals via a first radio frequency chain pair and the second plurality of training signals via a second radio frequency chain pair.

5. The first wireless communication device of claim 2, wherein the processing system is further configured to cause the first wireless communication device to:
measure a first received power for a first radio frequency chain pair comprising the first transmit radio frequency chain and the first receive radio frequency chain, a second received power for a second radio frequency chain pair comprising the second transmit radio frequency chain and the second receive radio frequency chain, a third received power for a third radio frequency chain pair comprising the first transmit radio frequency chain and the second receive radio frequency chain, and a fourth received power for a fourth radio frequency chain pair comprising the second transmit radio frequency chain and the first receive radio frequency chain in accordance with receiving the first plurality of training signals and the second plurality of training signals.

6. The first wireless communication device of claim 5, wherein the first radio frequency chain pair and the second radio frequency chain pair are selected according to a first sum of the first received power and the second received power being greater than a second sum of the third received power and the fourth received power.

7. The first wireless communication device of claim 1, wherein, to receive the plurality of training signals, the processing system is configured to cause the first wireless communication device to:
receive, over the second link via a first receive radio frequency chain of the plurality of receive radio frequency chains, a first plurality of training signals from a first transmit radio frequency chain and a second plurality of training signals from a second transmit radio frequency chain in accordance with the beam search trigger, the first plurality of training signals transmitted over a first subset of beamforming directions and the second plurality of training signals transmitted over a second subset of beamforming directions that is non-overlapping with the first subset of beamforming directions; and
receive, over the second link via a second receive radio frequency chain of the plurality of receive radio frequency chains, the first plurality of training signals from the first transmit radio frequency chain and the second plurality of training signals from the second transmit radio frequency chain in accordance with the beam search trigger, the first plurality of training signals transmitted over the first subset of beamforming directions and the second plurality of training signals transmitted over the second subset of beamforming directions.

8. The first wireless communication device of claim 7, wherein, to select the radio frequency chain pair for each spatial stream, the processing system is configured to cause the first wireless communication device to:
select a first radio frequency chain pair for a first spatial stream and a second radio frequency chain pair for a second spatial stream in accordance with receiving the first plurality of training signals and the second plurality of training signals.

9. The first wireless communication device of claim 7, wherein, to select the beamforming direction for each spatial stream, the processing system is configured to cause the first wireless communication device to:
select a first beamforming direction from the first subset of beamforming directions or the second subset of beamforming directions for a first spatial stream and a second beamforming direction from the first subset of beamforming directions or the second subset of beamforming directions for a second spatial stream in accordance with receiving the first plurality of training signals via a first radio frequency chain pair and the second plurality of training signals via a second radio frequency chain pair.

10. The first wireless communication device of claim 7, wherein the first plurality of training signals are polarized according to a first polarization, and the second plurality of training signals are polarized according to a second polarization.

11. The first wireless communication device of claim 1, wherein, to receive the plurality of training signals, the processing system is configured to cause the first wireless communication device to:
receive, over the second link via a first receive radio frequency chain, a first plurality of training signals over a plurality of beamforming directions in accordance with the beam search trigger, and, wherein to select the radio frequency chain pair for each spatial stream, the processing system is configured to cause the first wireless communication device to:
select a first beamforming direction from the plurality of beamforming directions for a first beam of a first spatial stream in accordance with receiving the first plurality of training signals; and
receive, over the second link via a second receive radio frequency chain, a second plurality of training signals over the plurality of beamforming directions excluding a subset of beamforming directions within a beam width of the first beam in accordance with the beam search trigger; and, wherein to select the radio frequency chain pair for each spatial stream, the processing system is configured to cause the first wireless communication device to:
select a second beamforming direction from the plurality of beamforming directions for a second beam of a second spatial stream in accordance with receiving the second plurality of training signals.

12. The first wireless communication device of claim 1, wherein the processing system is further configured to cause the first wireless communication device to:
transmit, via the first link or the second link, a feedback message indicating the radio frequency chain pair for each spatial stream and the beamforming direction for each spatial stream.

13. The first wireless communication device of claim 1, wherein the processing system is further configured to cause the first wireless communication device to:
measure a received power for all combinations of radio frequency chain pairs between the plurality of receive radio frequency chains and the plurality of transmit radio frequency chains, wherein the selected radio frequency chain pairs have a highest combined received power of all combinations of radio frequency chain pairs having a same quantity of radio frequency chain pairs as the selected radio frequency chain pairs.

14. A first wireless communication device, comprising:
a processing system that includes processor circuitry and memory circuitry that stores code, the processing system configured to cause the first wireless communication device to:
transmit, via a first link in a first radio frequency spectrum band, a beam search trigger for a second link in a second radio frequency spectrum band;
transmit, over the second link via a plurality of transmit radio frequency chains of the first wireless communication device, a plurality of training signals to a plurality of receive radio frequency chains of a second wireless communication device in accordance with the beam search trigger; and
receive a feedback message indicating a radio frequency chain pair for each spatial stream of a set of spatial streams and a beamforming direction for each spatial stream of the set of spatial streams.

15. The first wireless communication device of claim 14, wherein, to transmit the plurality of training signals, the processing system is configured to cause the first wireless communication device to:
transmit a first plurality of training signals over a plurality of beamforming directions via a first transmit radio frequency chain with a first polarization in accordance with the beam search trigger; and
transmit a second plurality of training signals over the plurality of beamforming directions via a second transmit radio frequency chain with a second polarization in accordance with the beam search trigger.

16. The first wireless communication device of claim 14, wherein, to transmit the plurality of training signals, the processing system is configured to cause the first wireless communication device to:
transmit a first plurality of training signals over a first subset of beamforming directions via a first transmit radio frequency chain in accordance with the beam search trigger; and
transmit a second plurality of training signals over a second subset of beamforming directions that is non-overlapping with the first subset of beamforming directions via a second transmit radio frequency chain in accordance with the beam search trigger.

17. The first wireless communication device of claim 14, wherein, to transmit the plurality of training signals, the processing system is configured to cause the first wireless communication device to:
transmit, via a first transmit radio frequency chain, a first plurality of training signals over a plurality of beamforming directions in accordance with the beam search trigger, wherein the feedback message indicates a first beam direction for a first spatial stream, the first beam direction associated with a first beam having a first beam width; and
transmit, via a second transmit radio frequency chain, a second plurality of training signals over the plurality of beamforming directions excluding a subset of beamforming directions within the first beam width of the first beam in accordance with the beam search trigger and the feedback message.

18. A method for wireless communication by a first wireless communication device, comprising:
receiving, via a first link in a first radio frequency spectrum band, a beam search trigger for a second link in a second radio frequency spectrum band;
receiving, over the second link via a plurality of receive radio frequency chains of the first wireless communication device, a plurality of training signals from a plurality of transmit radio frequency chains of a second wireless communication device in accordance with the beam search trigger;
selecting a radio frequency chain pair for each spatial stream of a set of spatial streams in accordance with the plurality of training signals, wherein each radio frequency chain pair comprises a receive radio frequency chain of the plurality of receive radio frequency chains and a transmit radio frequency chain of the plurality of transmit radio frequency chains; and
selecting a beamforming direction for each spatial stream of the set of spatial streams in accordance with the plurality of training signals.

19. The method of claim 18, wherein receiving the plurality of training signals comprises:
receiving, over the second link via a first receive radio frequency chain of the plurality of receive radio frequency chains, a first plurality of training signals from a first transmit radio frequency chain with a first polarization and, simultaneous to the first plurality of training signals, a second plurality of training signals from a second transmit radio frequency chain with a second polarization different from the first polarization, the first receive radio frequency chain having the first polarization, the first plurality of training signals and the second plurality of training signals received over each beamforming direction of a plurality of beamforming directions in accordance with the beam search trigger; and
receiving, over the second link via a second receive radio frequency chain of the plurality of receive radio frequency chains, the first plurality of training signals from the first transmit radio frequency chain with the first polarization and, simultaneous to the first plurality of training signals, the second plurality of training signals from the second transmit radio frequency chain with the second polarization, the second receive radio frequency chain having the second polarization, the first plurality of training signals and the second plurality of training signals received over each beamforming direction of the plurality of beamforming directions in accordance with the beam search trigger.

20. The method of claim 19, wherein selecting the radio frequency chain pair for each spatial stream comprises:
selecting a first radio frequency chain pair for a first spatial stream and a second radio frequency chain pair for a second spatial stream in accordance with receiving the first plurality of training signals and the second plurality of training signals.

21. The method of claim 19, wherein selecting the beamforming direction for each spatial stream comprises:
selecting a first beamforming direction from the plurality of beamforming directions for a first spatial stream and a second beamforming direction from the plurality of beamforming directions for a second spatial stream in accordance with receiving the first plurality of training signals via a first radio frequency chain pair and the second plurality of training signals via a second radio frequency chain pair.

22. The method of claim 19, further comprising:
measuring a first received power for a first radio frequency chain pair comprising the first transmit radio frequency chain and the first receive radio frequency chain, a second received power for a second radio frequency chain pair comprising the second transmit radio frequency chain and the second receive radio frequency chain, a third received power for a third radio frequency chain pair comprising the first transmit radio frequency chain and the second receive radio frequency chain, and a fourth received power for a fourth radio frequency chain pair comprising the second transmit radio frequency chain and the first receive radio frequency chain in accordance with receiving the first plurality of training signals and the second plurality of training signals.

23. The method of claim 22, wherein the first radio frequency chain pair and the second radio frequency chain pair are selected according to a first sum of the first received power and the second received power being greater than a second sum of the third received power and the fourth received power.

24. The method of claim 18, wherein receiving the plurality of training signals comprises:
receiving, over the second link via a first receive radio frequency chain of the plurality of receive radio frequency chains, a first plurality of training signals from a first transmit radio frequency chain and a second plurality of training signals from a second transmit radio frequency chain in accordance with the beam search trigger, the first plurality of training signals transmitted over a first subset of beamforming directions and the second plurality of training signals transmitted over a second subset of beamforming directions that is non-overlapping with the first subset of beamforming directions; and
receiving, over the second link via a second receive radio frequency chain of the plurality of receive radio frequency chains, the first plurality of training signals from the first transmit radio frequency chain and the second plurality of training signals from the second transmit radio frequency chain in accordance with the beam search trigger, the first plurality of training signals transmitted over the first subset of beamforming directions and the second plurality of training signals transmitted over the second subset of beamforming directions.

25. The method of claim 24, wherein selecting the radio frequency chain pair for each spatial stream comprises:
selecting a first radio frequency chain pair for a first spatial stream and a second radio frequency chain pair for a second spatial stream in accordance with receiving the first plurality of training signals and the second plurality of training signals.

26. The method of claim 24, wherein selecting the beamforming direction for each spatial stream comprises:
selecting a first beamforming direction from the first subset of beamforming directions or the second subset of beamforming directions for a first spatial stream and a second beamforming direction from the first subset of beamforming directions or the second subset of beamforming directions for a second spatial stream in accordance with receiving the first plurality of training signals via a first radio frequency chain pair and the second plurality of training signals via a second radio frequency chain pair.

27. The method of claim 24, wherein the first plurality of training signals are polarized according to a first polarization, and the second plurality of training signals are polarized according to a second polarization.

28. The method of claim 18, wherein receiving the plurality of training signals comprises:
receiving, over the second link via a first receive radio frequency chain, a first plurality of training signals over a plurality of beamforming directions in accordance with the beam search trigger, and wherein selecting the radio frequency chain pair for each spatial stream comprises:
selecting a first beamforming direction from the plurality of beamforming directions for a first beam of a first spatial stream in accordance with receiving the first plurality of training signals; and
receiving, over the second link via a second receive radio frequency chain, a second plurality of training signals over the plurality of beamforming directions excluding a subset of beamforming directions within a beam width of the first beam in accordance with the beam search trigger; and wherein selecting the radio frequency chain pair for each spatial stream comprises:
selecting a second beamforming direction from the plurality of beamforming directions for a second beam of a second spatial stream in accordance with receiving the second plurality of training signals.

29. The method of claim 18, further comprising:
transmitting, via the first link or the second link, a feedback message indicating the radio frequency chain pair for each spatial stream and the beamforming direction for each spatial stream.

30. The method of claim 18, further comprising:
measuring a received power for all combinations of radio frequency chain pairs between the plurality of receive radio frequency chains and the plurality of transmit radio frequency chains, wherein the selected radio frequency chain pairs have a highest combined received power of all combinations of radio frequency chain pairs having a same quantity of radio frequency chain pairs as the selected radio frequency chain pairs.

31. A method for wireless communication by a first wireless communication device, comprising:
transmitting, via a first link in a first radio frequency spectrum band, a beam search trigger for a second link in a second radio frequency spectrum band;
transmitting, over the second link via a plurality of transmit radio frequency chains of the first wireless communication device, a plurality of training signals to a plurality of receive radio frequency chains of a second wireless communication device in accordance with the beam search trigger; and
receiving a feedback message indicating a radio frequency chain pair for each spatial stream of a set of spatial streams and a beamforming direction for each spatial stream of the set of spatial streams.

32. The method of claim 31, wherein transmitting the plurality of training signals comprises:
transmitting a first plurality of training signals over a plurality of beamforming directions via a first transmit radio frequency chain with a first polarization in accordance with the beam search trigger; and
transmitting a second plurality of training signals over the plurality of beamforming directions via a second transmit radio frequency chain with a second polarization in accordance with the beam search trigger.

33. The method of claim 31, wherein transmitting the plurality of training signals comprises:
transmitting a first plurality of training signals over a first subset of beamforming directions via a first transmit radio frequency chain in accordance with the beam search trigger; and
transmitting a second plurality of training signals over a second subset of beamforming directions that is non-overlapping with the first subset of beamforming directions via a second transmit radio frequency chain in accordance with the beam search trigger.

34. The method of claim 31, wherein transmitting the plurality of training signals comprises:
transmitting, via a first transmit radio frequency chain, a first plurality of training signals over a plurality of beamforming directions in accordance with the beam search trigger, wherein the feedback message indicates a first beam direction for a first spatial stream, the first beam direction associated with a first beam having a first beam width; and
transmitting, via a second transmit radio frequency chain, a second plurality of training signals over the plurality of beamforming directions excluding a subset of beamforming directions within the first beam width of the first beam in accordance with the beam search trigger and the feedback message.
